(19) United States
(12) Patent Application Publication
(10) Pub. No.: US 2025/0042428 A1
(43) Pub. Date: Feb. 6, 2025

(54) PROCESSING SYSTEM AND INFORMATION PRESENTATION DEVICE

(71) Applicant: DENSO CORPORATION, Kariya-city (JP)

(72) Inventor: MASAKI YAMAOKA, Kariya-city (JP)

(21) Appl. No.: 18/924,076

(22) Filed: Oct. 23, 2024

Related U.S. Application Data
(63) Continuation of application No. PCT/JP2023/017910, filed on May 12, 2023.

(30) Foreign Application Priority Data
May 23, 2022 (JP) 2022-083974

(51) Int. Cl. B60W 50/14; B60W 40/08; B60W 40/09; B60W 50/00; B60W 60/00

(52) U.S. Cl. CPC B60W 50/14; B60W 40/09; B60W 50/0097; B60W 60/0015; B60W 2040/0818; B60W 2050/143; B60W 2050/146; B60W 2540/22; B60W 2540/229; B60W 2556/10; B60W 2556/45

(57) ABSTRACT

A processing system that executes a process for performing presentation to a driver of a moving object is provided. The processing system includes at least one processor. The processor executes evaluating driving of the driver using a rule defined by a safety model of autonomous driving, and outputting information related to teaching for complying with the rule in a presentable manner to the driver based on the evaluating.

### CROSS REFERENCE TO RELATED APPLICATION

The present application is a continuation application of International Patent Application No. PCT/JP2023/017910 filed on May 12, 2023, which designated the U.S. and claims the benefit of priority from Japanese Patent Application No. 2022-083974 filed on May 23, 2022. The entire disclosures of all of the above applications are incorporated herein by reference.

### TECHNICAL FIELD

The present disclosure relates to a technology for evaluation and teaching in driving in a moving object.

### BACKGROUND

In a related art, driving characteristics of a driver are evaluated. Specifically, evaluation of the driving characteristics includes evaluation of compliance with traffic rules and evaluation of a speed corresponding to a position based on a speed, a position, and map information of a vehicle driven by the driver.

### SUMMARY

A processing system that executes a process for performing presentation to a driver of a moving object is provided. The processing system includes at least one processor. The processor executes evaluating driving of the driver using a rule defined by a safety model of autonomous driving, and outputting information related to teaching for complying with the rule in a presentable manner to the driver based on the evaluating.

### BRIEF DESCRIPTION OF DRAWINGS

FIG. 1 is a block diagram illustrating a schematic configuration of a driving system.

FIG. 2 is a block diagram illustrating a configuration of the driving system at a technical level.

FIG. 3 is a block diagram illustrating a configuration of the driving system at a functional level.

FIG. 4 is a block diagram illustrating a configuration for implementing an evaluation function and a teaching function.

FIG. 5 is a diagram illustrating a scenario related to evaluation of driving.

FIG. 6 is a diagram illustrating a scenario related to evaluation of driving.

FIG. 7 is a diagram illustrating a scenario related to evaluation of driving.

FIG. 8 is a block diagram illustrating a configuration for implementing generation and presentation of content.

FIG. 9 is a block diagram illustrating a configuration for implementing generation and presentation of the content.

FIG. 10 is a block diagram illustrating a configuration for implementing generation and presentation of the content.

FIG. 11 is a diagram illustrating presented content.

FIG. 12 is a diagram illustrating the presented content.

FIG. 13 is a diagram illustrating the presented content.

FIG. 14 is a flowchart for describing an evaluation process and a teaching process.

FIG. 15 is a flowchart for describing an estimation process of a danger level.

FIG. 16 is a flowchart for describing a presentation process for a driver.

FIG. 17 is a flowchart for describing a presentation process during driving of the driver.

FIG. 18 is a flowchart for describing a presentation process after an end of driving of the driver.

FIG. 19 is a diagram for describing prediction of a driver state.

FIG. 20 is a flowchart for describing the estimation process of the danger level.

FIG. 21 is a diagram for describing estimation of a causal relationship.

FIG. 22 is a flowchart for describing the estimation process of the danger level.

FIG. 23 is a flowchart for describing the presentation process for the driver.

FIG. 24 is a flowchart for describing the presentation process for the driver.

### DETAILED DESCRIPTION

In recent years, development of autonomous driving technology in a moving object has rapidly progressed, and traveling of a moving object executing autonomous driving on a public road is about to be implemented. In this case, an environment in which a moving object driven by a driver coexists with a moving object autonomously driven in accordance with rules defined by a safety model for the autonomous driving is expected. In this environment, when the driver drives without taking the rules into consideration, driving of the driver may be relatively adversely evaluated.

The present disclosure provides a processing system and an information presentation device that increase validity of driving of a driver.

According to one aspect of the present disclosure, A processing system that executes a process for performing presentation to a driver of a moving object is provided. The processing system includes at least one processor. The processor executes evaluating driving of the driver using a rule defined by a safety model of autonomous driving, detecting a degree of deviation between the driving of the driver and the rule in the evaluating or separately from the evaluating, and outputting information related to teaching for complying with the rule in a presentable manner to the driver based on the evaluating. In the outputting, the information is output in accordance with the degree of the deviation.

According to one aspect of the present disclosure, a processing system that executes a process for performing presentation to a driver of a moving object is provided. The processing system includes at least one processor. The processor executes evaluating driving of the driver using a rule defined by a safety model of autonomous driving, outputting information related to teaching for complying with the rule in a presentable manner to the driver based on the evaluating, perceiving a state of the driver, extracting a causal relationship between the state of the driver and a potential hazard in the driving of the driver, and classifying a factor of occurrence of the potential hazard in accordance with the causal relationship. The teaching is teaching corresponding to classification of the factor of occurrence.

According to one aspect of the present disclosure, a processing system that executes a process for performing presentation to a driver of a moving object is provided. The processing system includes at least one processor. The processor executes evaluating driving of the driver using a rule defined by a safety model of autonomous driving, outputting information related to teaching for complying with the rule in a presentable manner to the driver based on the evaluating, predicting a scenario that is predicted to be encountered by the moving object due to the driving of the driver and in which the moving object falls into an unsafe condition. The teaching is teaching for causing the moving object to comply with the rule in the scenario in which the moving object falls into the unsafe condition.

According to one aspect of the present disclosure, a processing system that executes a process for performing presentation to a driver of a moving object is provided. The processing system includes at least one processor. The processor executes evaluating driving of the driver using a rule defined by a safety model of autonomous driving, outputting information related to teaching for complying with the rule in a presentable manner to the driver based on the evaluating, and determining a presentation mode of presentation content for performing the teaching based on a result of the evaluating of the driving of the driver.

According to these aspects, the information related to the teaching to the driver is output in a presentable manner to the driver. The rule as a reference for the teaching to the driver is defined by the safety model of autonomous driving. By causing the driver to refer to this teaching, adverse evaluation of driving of the driver in evaluation relative to an autonomously driven moving object can be restricted. Therefore, validity of driving of the driver can be increased.

According to one aspect of the present disclosure, an information presentation device that performs presentation to a user is provided. The device includes: a communication interface that is configured to communicate with a processing system which executes a process related to a moving object and that is configured to acquire information related to teaching for causing a driver of the moving object to comply with a rule defined by a safety model of autonomous driving from the processing system; and a user interface that is configured to present presentation content related to the teaching for complying with the rule based on the information. The presentation content includes content in which visual information indicating a scenario that is encountered by the moving object due to driving of the driver and audio information for providing advice on improving driving in the scenario are combined.

According to this aspect, the user interface presents the presentation content based on the information that is related to the teaching to the driver and that is acquired from the communication interface. The rule as the reference for the teaching to the driver is defined by the safety model of autonomous driving. By causing the driver to refer to this teaching, adverse evaluation of driving of the driver in evaluation relative to an autonomously driven moving object can be restricted. Therefore, the validity of driving of the driver can be increased.

Hereinafter, multiple embodiments will be described based on the drawings. Duplicate descriptions may be omitted by designating corresponding components by the same reference numerals in each embodiment. When only a part of a configuration is described in each embodiment, a configuration of another embodiment described earlier can be applied to the other part of the configuration. Not only configurations explicitly described in each embodiment can be combined, but also configurations of multiple embodiments that are not explicitly described can be partially combined unless the combination particularly poses an issue.

In the following multiple embodiments, content of “Safety First for Automated Driving”, Tech. Rep., 2019 by Aptiv, Audi, Baidu, BMW, Continental, Daimler, FCA, HERE, Infineon, Intel, and Volkswagen, content of “On a formal model of safe and scalable self-driving cars”, arXiv:1708.06374, 2017 by S. Shalev-Shwartz, S. Shammah, and A. Shashua, and content of “The Safety Force Field” Technical Report, 2019 by David Nister, Hon-Leung Lee, Julia Ng, and Yizhou Wang are incorporated by reference in their entirety.

### First Embodiment

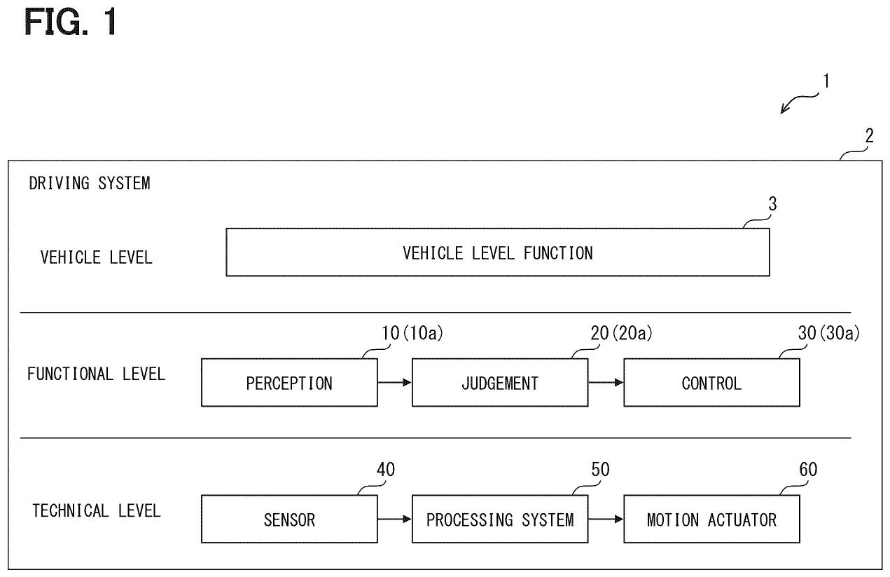

A driving system 2 of a first embodiment illustrated in FIG. 1 implements a function related to driving of a moving object. A part of the entirety of the driving system 2 is mounted on the moving object. The moving object that is a target to be processed by the driving system 2 is a vehicle 1. The vehicle 1 can be referred to as a subject vehicle and corresponds to a host moving object. The vehicle 1 may be configured to communicate with another vehicle directly or indirectly through communication infrastructure. The other vehicle corresponds to a target moving object.

The vehicle 1 may be, for example, a road user capable of executing manual driving of an automobile or a truck. The vehicle 1 may further be capable of executing autonomous driving. Levels of driving are divided in accordance with a scope or the like of tasks performed by a driver among all dynamic driving tasks (DDTs). Levels of driving automation is defined in, for example, SAE J3016. At levels 0 to 2, the driver performs a part or all of the DDTs. Levels 0 to 2 may be classified as so-called manual driving. Level 0 indicates that driving is not automated. Level 1 indicates that the driving system 2 supports the driver. Level 2 indicates that driving is partially automated.

At level 3 or higher, the driving system 2 performs all of the DDTs while the driving system 2 is engaged. Levels 3 to 5 may be classified as so-called autonomous driving. A system capable of executing driving at level 3 or higher may be referred to as an automated driving system. Level 3 indicates that driving is conditionally automated. Level 4 indicates that driving is highly automated. Level 5 indicates that driving is fully automated.

The driving system 2 that is not capable of executing driving at level 3 or higher and that is capable of executing driving at at least one of levels 1 and 2 may be referred to as a driver-assistance system. In the following description, the automated driving system or the driving support system may be simply referred to as the driving system 2 unless otherwise the highest driving automation level that can be implemented is specified.

### <Sense-Plan-Act Model>

Architecture of the driving system 2 that enables implementation of an efficient safety of the intended functionality (SOTIF) process is selected. For example, the architecture of the driving system 2 may be configured based on a sense-plan-act model. The sense-plan-act model includes a sense (perception) element, a plan (planning) element, and an act (action) element as main system elements. The sense element, the plan element, and the act element interact with each other. Sense can be replaced with perception, plan can be replaced with judgement, and act can be replaced with control.

As illustrated in FIG. 1, at a vehicle level in the driving system 2, a vehicle level function 3 is implemented based on a vehicle level safety strategy (VSLL). At a functional level (in other words, a functional perspective), a perception function, a judgement function, and a control function are implemented. At a technical level (in other words, a technical perspective), at least multiple sensors 40 corresponding to the perception function, at least one processing system 50 corresponding to the judgement function, and multiple motion actuators 60 corresponding to the control function are implemented.

Specifically, a perception unit 10 as a functional block for implementing the perception function mainly using the multiple sensor 40, a processing system that processes detection information of the multiple sensors 40, and a processing system that generates an environment model based on information of the multiple sensor 40 may be constructed in the driving system 2. A judgement unit 20 as a functional block for implementing the judgement function mainly using the processing system 50 may be constructed in the driving system 2. A control unit 30 as a functional block for implementing the control function mainly using the multiple motion actuators 60 and at least one processing system that outputs operation signals of the multiple motion actuators 60 may be constructed in the driving system 2.

The perception unit 10 may be implemented in a form of a perception system 10a as a subsystem that is provided in a distinguishable manner from the judgement unit 20 and the control unit 30. The judgement unit 20 may be implemented in a form of a judgement system 20a as a subsystem that is provided in a distinguishable manner from the perception unit 10 and the control unit 30. The control unit 30 may be implemented in a form of a control system 30a as a subsystem that is provided in a distinguishable manner from the perception unit 10 and the judgement unit 20. The perception system 10a, the judgement system 20a, and the control system 30a may form components that are independent of each other.

Furthermore, multiple human machine interface (HMI) devices 70 may be mounted on the vehicle 1. A part of the multiple HMI devices 70 that implements an operation input function for an occupant may be a part of the perception unit 10. A part of the multiple HMI devices 70 that implements an information presentation function may be a part of the control unit 30. Meanwhile, a function implemented by the HMI device 70 may be positioned as a function independent of the perception function, the judgement function, and the control function.

The perception unit 10 performs the perception function including localization (for example, estimation of a position) of the road user such as the vehicle 1 and the other vehicle. The perception unit 10 detects an external environment, an internal environment, and a vehicle state of the vehicle 1 and furthermore, a state of the driving system 2. The perception unit 10 generates the environment model by combining detected information. The judgement unit 20 derives a control action by applying a purpose and a driving policy to the environment model generated by the perception unit 10. The control unit 30 executes the control action derived by the judgement unit 20.

### <System Configuration at Technical Level>

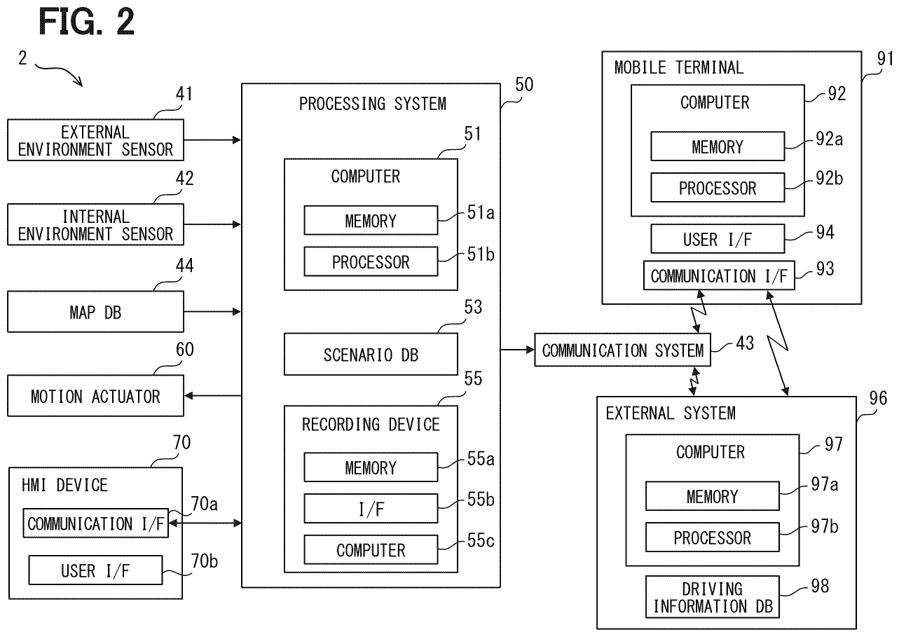

An example of a specific configuration of the driving system 2 at the technical level will be described using FIG. 2. The configuration at the technical level may mean physical architecture. The driving system 2 includes the multiple sensors 40, the multiple motion actuators 60, the multiple HMI devices 70, and at least one processing system. These components are capable of communicating with each other through one or both of wireless connection and wired connection. These components may be capable of communicating with each other through, for example, an in-vehicle network such as a CAN (registered trademark).

The multiple sensors 40 include one or multiple external environment sensors 41. The multiple sensors 40 may include at least one type of one or multiple internal environment sensors 42, one or multiple communication systems 43, and a map database (DB) 44. When the sensor 40 is interpreted in a narrow meaning to indicate the external environment sensor 41, the internal environment sensor 42, the communication system 43, and the map DB 44 may be positioned as separate components from the sensor 40 corresponding to the technical level of the perception function.

The external environment sensor 41 may detect targets present in the external environment of the vehicle 1. The external environment sensor 41 of a target detection type is, for example, a camera 41a, a light detection and ranging/laser imaging detection and ranging (LiDAR) 41b, a laser radar, a millimeter wave radar, an ultrasonic sonar, or an imaging radar. As a typical sensor mounting example, multiple cameras 41a (for example, 11 cameras 41a) configured to monitor each of directions of a front, a front side, a side, a rear side, and a rear of the vehicle 1 may be mounted on the vehicle 1.

As another mounting example, multiple cameras 41a (for example, four cameras 41a) configured to monitor each of the front, the side, and the rear of the vehicle 1, multiple millimeter wave radars (for example, five millimeter wave radars) configured to monitor each of the front, the front side, the side, and the rear of the vehicle 1, and the LiDAR 41b configured to monitor the front of the vehicle 1 may be mounted on the vehicle 1.

Furthermore, the external environment sensor 41 may detect a state of an atmosphere or a state of the weather in the external environment of the vehicle 1. The external environment sensor 41 of a state detection type is, for example, an outside air temperature sensor, a temperature sensor, or a raindrop sensor.

The internal environment sensor 42 may detect a specific physical quantity (hereinafter, a motion physical quantity) related to a vehicle motion in the internal environment of the vehicle 1. The internal environment sensor 42 of a motion physical quantity detection type is, for example, a speed sensor 42c, an acceleration sensor, or a gyro sensor. The internal environment sensor 42 may detect the state of the occupant (for example, a driver state) in the internal environment of the vehicle 1. The internal environment sensor 42 of an occupant detection type is, for example, an actuator sensor, a sensor and a system (hereinafter, a driver monitor 42a) that monitor the driver, a biosensor, a pulse wave sensor 42b, a seating sensor, and a vehicle device sensor. The accelerator sensor is particularly, for example, an accelerator sensor, a brake sensor, or a steering sensor that detects an operating state of the driver with respect to the motion actuator 60 related to a motion control of the vehicle 1.

The communication system 43 acquires communication data usable in the driving system 2 through wireless communication. The communication system 43 may receive a positioning signal from an artificial satellite of a global navigation satellite system (GNSS) present in the external environment of the vehicle 1. A communication device of a positioning type in the communication system 43 is, for example, a GNSS receiver.

The communication system 43 may transmit and receive a communication signal to and from an external system 96 present in the external environment of the vehicle 1. A communication device of a V2X type in the communication system 43 is, for example, a dedicated short range communications (DSRC) communication device or a cellular V2X (C-V2X) communication device. Examples of communication with the external system 96 present in the external environment of the vehicle 1 include communication (V2V) with a system of the other vehicle, communication (V21) with an infrastructure facility such as a communication device set in a traffic light, communication (V2P) with a mobile terminal of a pedestrian, and communication (V2N) with a network such as a cloud server.

Furthermore, the communication system 43 may transmit and receive a communication signal to and from, for example, a mobile terminal 91 such as a smartphone carried in the vehicle in the internal environment of the vehicle 1. A communication device of a terminal communication type in the communication system 43 is, for example, a Bluetooth (registered trademark) communication device, a Wi-Fi (registered trademark) communication device, or an infrared communication device.

The map DB 44 is a database storing map data usable in the driving system 2. The map DB 44 includes, for example, a non-transitory tangible storage medium of at least one type of a semiconductor memory, a magnetic medium, and an optical medium. The map DB 44 may include a database of a navigation unit that navigates a travel path of the vehicle 1 to a destination. The map DB 44 may include a database of a high-accuracy map having a high level of accuracy mainly used for an automated driving system. The map DB 44 may include a database of a parking lot map including specific parking lot information, for example, parking frame information, used for automated parking or parking support.

The map DB 44 suitable for the driving system 2 may acquire and store the most recent map data by communicating with a map server through, for example, the communication system 43 of the V2X type. The map data is converted into two-dimensional or three-dimensional data as data indicating the external environment of the vehicle 1. The map data may include, for example, marking data indicating at least one type of a position coordinate, a shape, a road surface state, and standard route of a road structure. The marking data included in the map data may include, for example, marking data indicating at least one type of a position coordinate and a shape of a traffic sign, a road marking, and a lane marking among the targets. The marking data included in the map data may indicate, for example, a traffic sign, an arrow marking, a lane marking, a stop line, a direction sign, a landmark beacon, a business sign, or a change in a line pattern of a road among the targets. The map data may include, for example, structure data indicating at least one type of a position coordinate and a shape of a building and a traffic light facing a road. The marking data included in the map data may indicate, for example, a street light, an edge of a road, a reflecting plate, or a ball among the targets.

The motion actuator 60 is capable of controlling the vehicle motion based on an input control signal. The motion actuator 60 of a drive type is, for example, a power train including at least one type of an internal combustion engine and a drive motor. The motion actuator 60 of a control type is, for example, a brake actuator. The motion actuator 60 of a steering type is, for example, steering.

At least one of the HMI devices 70 may be an operation input device into which an operation of the occupant including the driver for delivering a decision or an intention of the occupant including the driver of the vehicle 1 to the driving system 2 can be input. The HMI device 70 of an operation input type is, for example, an accelerator pedal, a brake pedal, a shift lever, a steering wheel, a turn signal lever, a mechanical switch, or a touch panel of the navigation unit. Among the examples, the accelerator pedal controls the power train as the motion actuator 60. The brake pedal controls the brake actuator as the motion actuator 60. The steering wheel controls a steering actuator as the motion actuator 60.

At least one of the HMI devices 70 may be an information presentation device including a user interface 70b that presents information such as visual information, audio information, or haptic information to the occupant including the driver of the vehicle 1. The HMI device 70 of a visual information presentation type is, for example, a graphic meter, a combination meter, the navigation unit, a center information display (CID), a head-up display (HUD), or an illumination unit. The HMI device 70 of an audio information presentation type is, for example, a speaker or a buzzer. The HMI device 70 of a haptic information presentation type is, for example, a vibration unit of the steering wheel, a vibration unit of a driver's seat, a reaction force unit of the steering wheel, a reaction force unit of the accelerator pedal, a reaction force unit of the brake pedal, or an air conditioning unit.

The HMI devices 70 may implement HMI functions in cooperation with the terminal 91 by communicating with the mobile terminal 91 such as the smartphone through the communication system 43. For example, the HMI devices 70 may present information acquired from the smartphone to the occupant including the driver. For example, operation input provided into the smartphone may replace operation input provided into the HMI devices 70. The mobile terminal 91 capable of communicating with the driving system 2 through the communication system 43 may function as the HMI devices 70.

As described above, the HMI devices 70 may include a communication interface 70a and the user interface 70b. When, for example, the visual information is presented, the user interface 70b may include a device that presents the visual information, such as a display that displays an image or a light that emits light. The user interface 70b may further include a circuit for controlling the device. The communication interface 70a may include at least one type of a circuit and a terminal for communicating with another device or another system through the in-vehicle network.

At least one processing system 50 is provided. For example, the processing system 50 may be an integrated processing system that executes a process related to the perception function, a process related to the judgement function, and a process related to the control function in an integrated manner. In this case, the integrated processing system 50 may further execute a process related to the HMI functions, or a processing system dedicated to the HMI functions may be separately provided. For example, the processing system dedicated to the HMI functions may be an integrated cockpit system that executes a process related to each HMI device in an integrated manner.

For example, the processing system 50 may include each of at least one processing unit corresponding to the process related to the perception function, at least one processing unit corresponding to the process related to the judgement function, and at least one processing unit corresponding to the process related to the control function.

The processing system 50 includes an external interface and is connected to at least one type of element related to a process of the processing system 50 through communication means. The communication means is, for example, at least one type of a local area network (LAN), the CAN (registered trademark), a wire harness, an internal bus, and a wireless communication circuit. Elements related to the process of the processing system 50 are the sensor 40, the motion actuator 60, the HMI devices 70, and the like.

The processing system 50 includes at least one dedicated computer 51. The processing system 50 may be combined with multiple dedicated computers 51 to implement functions such as the perception function, the judgement function, the control function, and the HMI function.

For example, the dedicated computer 51 forming the processing system 50 may be an integrated ECU that integrates driving functions of the vehicle 1. The dedicated computer 51 forming the processing system 50 may be a judgement ECU that judges the DDTs. The dedicated computer 51 forming the processing system 50 may be a monitoring ECU that monitors driving of the vehicle 1. The dedicated computer 51 forming the processing system 50 may be an evaluation ECU that evaluates driving of the vehicle 1. The dedicated computer 51 forming the processing system 50 may be a navigation ECU that navigates the travel path of the vehicle 1.

The dedicated computer 51 forming the processing system 50 may be a locator ECU that estimates a position of the vehicle 1. The dedicated computer 51 forming the processing system 50 may be an image processing ECU that processes image data detected by the external environment sensor 41. The dedicated computer 51 forming the processing system 50 may be an HMI control unit (HCU) that controls the HMI devices 70 in an integrated manner.

The dedicated computer 51 forming the processing system 50 may include at least one memory 51a and at least one processor 51b. The memory 51a may be, for example, a non-transient tangible storage medium of at least one type of a semiconductor memory, a magnetic medium, and an optical medium that stores a program, data, and the like readable by the processor 51b in a non-transitory manner. Furthermore, for example, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

The dedicated computer 51 forming the processing system 50 may be a system on a chip (SoC) in which a memory, a processor, and an interface are implemented in an integrated manner on one chip, or the SoC may be provided as a component of the dedicated computer 51.

Furthermore, the processing system 50 may include at least one database for executing a dynamic driving task. The database may include, for example, a non-transient tangible storage medium of at least one type of a semiconductor memory, a magnetic medium, and an optical medium, and an interface for accessing the storage medium. The database may be a scenario DB 53 that is a database of a scenario structure. The scenario DB 53 may not be provided in the driving system 2 and, for example, may be constructed in the external system 96 such that the scenario DB 53 is accessible from the processing system 50 of the vehicle 1 through the communication system 43.

The scenario DB 53 may include at least one of a functional scenario, a logical scenario, and a concrete scenario. The functional scenario defines the highest-level qualitative scenario structure. The logical scenario is a scenario obtained by assigning a quantitative parameter range to the structured functional scenario. The concrete scenario defines a safety determination boundary for distinguishing between a safe state and unsafe conditions.

The processing system 50 may include at least one recording device 55 for recording at least one of perception information, judgement information, and control information of the driving system 2. The recording device 55 may include at least one memory 55a and an interface 55b for writing data into the memory 55a. The memory 55a may be, for example, a non-transient tangible storage medium of at least one type of a semiconductor memory, a magnetic medium, and an optical medium.

At least one of the memories 55a may be implemented on a substrate in a non-easily detachable and replaceable form. In this form, for example, an embedded multimedia card (eMMC) using a flash memory may be employed. At least one of the memories 55a may be in a detachable and replaceable form with respect to the recording device 55. In this form, for example, an SD card may be employed.

The recording device 55 may have a function of selecting information to be recorded among the perception information, the judgement information, and the control information. In this case, the recording device 55 may include a dedicated computer 55c. In the dedicated computer 55c provided in the recording device 55, a processor may store information in a RAM or the like in a transitory manner. The processor may select information to be recorded in a non-transitory manner from the information stored in a transitory manner and store the selected information in the memory 51a.

The mobile terminal 91 capable of communicating the processing system 50 through the communication system 43 may be, for example, a smartphone or a tablet terminal. The mobile terminal 91 may include, for example, a dedicated computer 92, a user interface 94, and a communication interface 93.

The dedicated computer 92 forming the mobile terminal 91 may include at least one memory 92a and at least one processor 92b. The memory 92a may be, for example, a non-transient tangible storage medium of at least one type of a semiconductor memory, a magnetic medium, and an optical medium that stores a program, data, and the like readable by the processor 92b in a non-transitory manner. Furthermore, for example, a rewritable volatile storage medium such as a random access memory (RAM) may be provided as the memory 92a. The processor 92b includes, for example, at least one type of a central processing unit (CPU), a graphics processing unit (GPU), and a reduced instruction set computer (RISC)-CPU as a core.

The user interface 94 may include a display and a speaker. The display may be, for example, a display capable of displaying a color image, such as a liquid crystal display or an OLED display. The display and the speaker are capable of presenting information to a user under control of the dedicated computer 92.

The communication interface 93 transmits and receives a communication signal to and from an external device or system. The communication interface 93 may include at least one type of communication devices such as a cellular V2X (C-V2X) communication device, a Bluetooth (registered trademark) communication device, a Wi-Fi (registered trademark) communication device, and an infrared communication device.

The external system 96 capable of communicating with the processing system 50 through the communication system 43 may be, for example, a cloud server or a remote center. The external system 96 may include at least one dedicated computer 97 and at least one driving information DB 98.

The dedicated computer 97 forming the external system 96 may include at least one memory 97a and at least one processor 97b. The memory 97a may be, for example, a non-transient tangible storage medium of at least one type of a semiconductor memory, a magnetic medium, and an optical medium that stores a program, data, and the like readable by the processor 97b in a non-transitory manner. Furthermore, for example, a rewritable volatile storage medium such as a random access memory (RAM) may be provided as the memory 97a. The processor 97b includes, for example, at least one type of a central processing unit (CPU), a graphics processing unit (GPU), and a reduced instruction set computer (RISC)-CPU as a core.

The driving information DB 98 is a database in which information related to driving of multiple vehicles including the vehicle 1 is recorded and accumulated. The driving information DB 98 may include, for example, a non-transient tangible storage medium of at least one type of a semiconductor memory, a magnetic medium, and an optical medium that has a high-capacity storage area and that stores data and the like readable by the processor 97b in a non-transitory manner, and an interface for accessing the storage medium.

### <System Configuration at Functional Level>

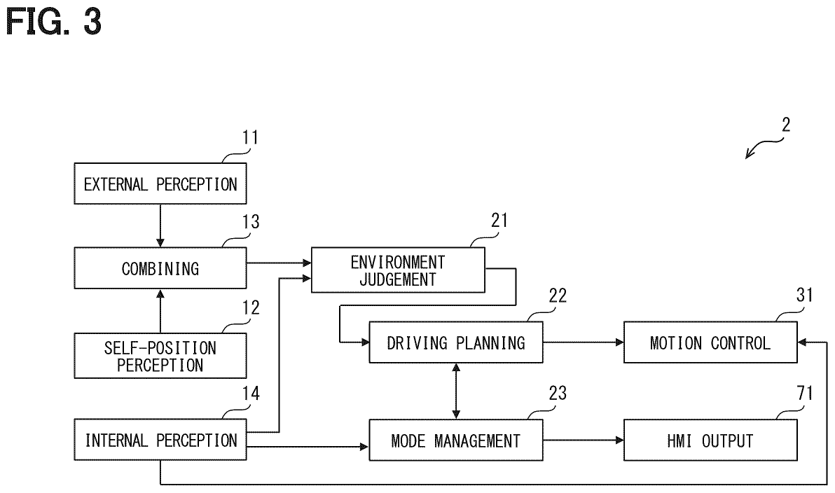

Next, an example of a specific configuration of the driving system 2 at the functional level will be described using FIG. 3. The configuration at the functional level may mean logical architecture. The perception unit 10 may include an external perception unit 11, a self-position perception unit 12, a combining unit 13, and an internal perception unit 14 as sub-blocks into which the perception function is further classified.

The external perception unit 11 implements a function of perceiving an object such as the target or another road user by individually processing detection data detected by each external environment sensor 41. The detection data may be, for example, detection data provided from a millimeter wave radar, a sonar, or the LiDAR 41b. The external perception unit 11 may generate relative position data including a direction, a size, and a distance of the object with respect to the vehicle 1 from unprocessed data detected by the external environment sensor 41.

The detection data may be, for example, image data provided from the camera 41a or the LiDAR 41b. The external perception unit 11 processes the image data and extracts the object captured within an angle of view of an image. Extraction of the object may include estimation of the direction, the size, and the distance of the object with respect to the vehicle 1. Extraction of the object may include, for example, classification of the object using semantic segmentation.

The self-position perception unit 12 performs localization of the vehicle 1. The self-position perception unit 12 acquires global position data of the vehicle 1 from the communication system 43 (for example, the GNSS receiver). The self-position perception unit 12 may acquire at least one of position information of the target extracted by the external perception unit 11 and position information of the target extracted by the combining unit 13. The self-position perception unit 12 acquires map information from the map DB 44. The self-position perception unit 12 integrates these types of information to estimate the position of the vehicle 1 on a map.

The combining unit 13 combines external perception information of each external environment sensor 41 processed by the external perception unit 11, localization information processed by the self-position perception unit 12, and V2X information acquired by the V2X.

The combining unit 13 combines object information of the other road user or the like individually perceived by each external environment sensor 41 to specify a type and a relative position of the object around the vehicle 1. The combining unit 13 combines target information of the road individually perceived by each external environment sensor 41 to specify a static structure of the road around the vehicle 1. The static structure of the road includes, for example, curvature of a curve, the number of lanes, and a free space.

Next, the combining unit 13 combines the type and the relative position of the object around the vehicle 1, the static structure of the road, the localization information, and the V2X information to generate the environment model. The environment model can be provided to the judgement unit 20. The environment model may be a model specialized for modeling the external environment.

The environment model may be an integrated model that is implemented by adding acquired information and that is obtained by combining information such as the internal environment, the vehicle state, and the state of the driving system 2. For example, the combining unit 13 may acquire a traffic rule such as a traffic code and reflect the traffic rule on the environment model.

The internal perception unit 14 implements a function of perceiving the vehicle state by processing detection data detected by each internal environment sensor 42. The vehicle state may include a state of the motion physical quantity of the vehicle 1 detected by the speed sensor 42c, the acceleration sensor, the gyro sensor, or the like. The vehicle state may include at least one type of the state of the occupant including the driver, the operating state of the driver with respect to the motion actuator 60, and a switching state of the HMI devices 70.

The judgement unit 20 may include an environment judgement unit 21, a driving planning unit 22, and a mode management unit 23 as sub-blocks into which the judgement function is further classified.

The environment judgement unit 21 acquires the environment model generated by the combining unit 13, the vehicle state perceived by the internal perception unit 14, and the like and performs judgement about the environment based on the environment model, the vehicle state, and the like. Specifically, the environment judgement unit 21 may estimate a situation in which the vehicle 1 is currently present by interpreting the environment model. The situation here may be an operational situation. The environment judgement unit 21 may predict an action of the other road user by interpreting the environment model. The environment judgement unit 21 may predict a path of the object such as the other road user by interpreting the environment model. The environment judgement unit 21 may predict a potential hazard by interpreting the environment model.

The environment judgement unit 21 may perform judgement related to a scenario in which the vehicle 1 is currently present, by interpreting the environment model. The judgement related to the scenario may be selection of at least one scenario in which the vehicle 1 is currently present from a catalog of scenarios constructed in the scenario DB 53.

Furthermore, the environment judgement unit 21 may estimate the intention of the driver based on at least one of the predicted action, the predicted path of the object, the predicted potential hazard, and the judgement related to the scenario and on the vehicle state provided from the internal perception unit 14.

The driving planning unit 22 plans driving of the vehicle 1 based on at least one type of estimation information of the position of the vehicle 1 on the map provided by the self-position perception unit 12, judgement information and driver intention estimation information provided by the environment judgement unit 21, functional constraint information provided by the mode management unit 23, and the like.

The driving planning unit 22 implements a route planning function, a behavior planning function, and a course planning function. The route planning function is a function of planning at least one of a route to the destination and a lane plan at a middle distance based on the estimation information of the position of the vehicle 1 on the map. The route planning function may further include a function of determining at least one request of a lane changing request and a deceleration request based on the lane plan at the middle distance. The route planning function may be a mission/route planning function in a strategic function or may be a function of outputting a mission plan and a route plan.

The behavior planning function is a function of planning behavior of the vehicle 1 based on at least one of the route to the destination and the lane plan at the middle distance planned by the route planning function, the lane changing request and the deceleration request, the judgement information and the driver intention estimation information provided by the environment judgement unit 21, and the functional constraint information provided by the mode management unit 23. The behavior planning function may include a function of generating a condition related to a state transition of the vehicle 1. The condition related to the state transition of the vehicle 1 may correspond to a triggering condition. The behavior planning function may include a function of determining a state transition of an application implementing the DDTs and furthermore, a state transition of a driving action based on the condition. The behavior planning function may include a function of determining a longitudinal direction constraint related to a path of the vehicle 1 and a lateral direction constraint related to the path of the vehicle 1 based on information about these state transitions. The behavior planning function may be a strategic behavior plan in a DDT function or may output strategic behavior.

The course planning function is a function of planning a travel course of the vehicle 1 based on the judgement information provided by the environment judgement unit 21, the longitudinal direction constraint related to the path of the vehicle 1, and the lateral direction constraint related to the path of the vehicle 1. The course planning function may include a function of generating a path plan. The path plan may include a speed plan, or the speed plan may be generated as a plan independent of the path plan. The course planning function may include a function of generating multiple path plans and selecting an optimal path plan from the multiple path plans or a function of switching between the path plans. The course planning function may further include a function of generating backup data of the generated path plan. The course planning function may be a course planning function in the DDT function or may output a course plan.

The mode management unit 23 monitors the driving system 2 and sets a functional constraint related to driving. The mode management unit 23 may manage a mode of autonomous driving, for example, a state of the driving automation level. Management of the driving automation level may include switching between manual driving and autonomous driving, that is, permission transfer between the driver and the driving system 2, in other words, management of takeover. The mode management unit 23 may monitor a state of a subsystem related to the driving system 2 and determine a defect of the system (for example, an error, an unstable operating state, a system failure, or a malfunction). The mode management unit 23 may determine a mode based on the intention of the driver, depending on the driver intention estimation information generated by the internal perception unit 14. The mode management unit 23 may set the functional constraint related to driving based on at least one of a determination result of the defect of the system, a determination result of the mode, and furthermore, the vehicle state provided by the internal perception unit 14, a sensor abnormality (or sensor malfunction) signal output from the sensor 40, state transition information of the application and the course plan provided by the driving planning unit 22, and the like.

The mode management unit 23 may have a function of determining the longitudinal direction constraint related to the path of the vehicle 1 and the lateral direction constraint related to the path of the vehicle 1 in an integrated manner, in addition to the functional constraint related to driving. In this case, the driving planning unit 22 plans the behavior and plans a course in accordance with the constraints determined by the mode management unit 23.

The control unit 30 may include a motion control unit 31 and an HMI output unit 71 as sub-blocks into which the control function is further classified. The motion control unit 31 controls a motion of the vehicle 1 based on the course plan (for example, the path plan and the speed plan) acquired from the driving planning unit 22. Specifically, the motion control unit 31 generates accelerator request information, shift request information, brake request information, and steering request information corresponding to the course plan and outputs the accelerator request information, the shift request information, the brake request information, and the steering request information to the motion actuator 60.

The motion control unit 31 is capable of directly acquiring the vehicle state, for example, at least one of a current speed, current acceleration, and a current yaw rate of the vehicle 1, perceived by the perception unit 10 (particularly, the internal perception unit 14) from the perception unit 10 and reflecting the vehicle state on the motion control of the vehicle 1.

The HMI output unit 71 outputs information related to an HMI based on at least one of the judgement information and the driver intention estimation information provided by the environment judgement unit 21, the state transition information of the application and the course plan provided by the driving planning unit 22, functional constraint information provided by the mode management unit 23, and the like. The HMI output unit 71 may manage vehicle interaction. The HMI output unit 71 may generate a notification request based on a management state of the vehicle interaction and control the information presentation function of the HMI devices 70. Furthermore, the HMI output unit 71 may generate control requests for a wiper, a sensor cleaning device, a headlight, and an air conditioner based on the management state of the vehicle interaction and control these devices.

### <Safety Model and Its Rules>

The driving system 2 may be configured to incorporate an assumption about reasonably foreseeable behavior of the other road user taken into consideration in a safety model of autonomous driving. For example, the safety model may correspond to a safety-related model or may correspond to a formal model. While, for example, a responsibility-sensitive safety (RSS) model or a safety force field (SFF) model may be employed as the safety model, other models, a more generalized model, or a composite model in which multiple models are combined may be employed.

For example, in the RSS model, five rules (five principles) are employed. A first rule is “Do not hit someone from behind”. A second rule is “Do not cut-in recklessly”. A third rule is “Right-of-way is given, not taken”. A fourth rule is “Be careful of area with limited visibility”. A fifth rule is “If you can avoid an accident without causing another one, you must do it”. These rules may correspond to a rule defined by the safety model of autonomous driving.

A safety envelope may be defined based on the five rules, particularly the first rule and the second rule. The safety envelope may mean a safety distance in the longitudinal direction and a safety distance in the lateral direction with respect to the other road user or may mean a condition or a concept for calculating these safety distances. The safety distance in the longitudinal direction and the safety distance in the lateral direction may be calculated by taking into consideration the reasonably foreseeable assumption about the other road user.

The safety distance in the longitudinal direction may be a distance in which, when a preceding vehicle during traveling at a predetermined speed stops by braking at a maximum speed, a following vehicle does not collide with the preceding vehicle even if the following vehicle accelerates with maximum acceleration in a predetermined response time and then stops by braking with minimum deceleration. The safety distance in the longitudinal direction may be a distance in which two vehicles do not collide head-on even if the two vehicles during traveling toward each other at their respective speeds accelerate with maximum acceleration in a predetermined response time and then stop by braking with minimum deceleration.

The safety distance in the lateral direction may be a distance in which two vehicles maintain a minimum distance and do not collide even if the two vehicles during traveling side by side at their respective lateral speeds accelerate with maximum acceleration in a predetermined response time and then decelerate in the lateral direction with maximum deceleration.

For example, in the SFF model, one core principle is employed. This principle is “every actor is required to apply a safety control action that contributes to at least the same extent as a safety procedure for improving safety potential”. This principle may correspond to the rule defined by the safety model of autonomous driving.

A volume of space-time between two deceleration schedules of a safety procedure schedule and a maximum braking schedule is defined as a claimed set. The safety potential may be defined as an indicator of an overlap between the claimed sets of two vehicles. An SFF may be defined as a negative gradient of the safety potential.

### <Evaluation and Teaching in Driving>

The driving system 2 of the present embodiment has a function (hereinafter, an evaluation function) of evaluating driving and a function (hereinafter, a teaching function) of performing teaching with respect to a driver who executes manual driving and a driver who executes manual driving under driving support. The driver executing manual driving may be a driver who drives the vehicle 1 in a state of driving automation level 0. The driver executing manual driving under the driving support may be a driver who drives the vehicle 1 in a state of driving automation level 1 or 2. The driving system 2 is capable of presenting the teaching to comply with the rule defined by the safety model of an autonomous driving model to the driver through the HMI devices 70.

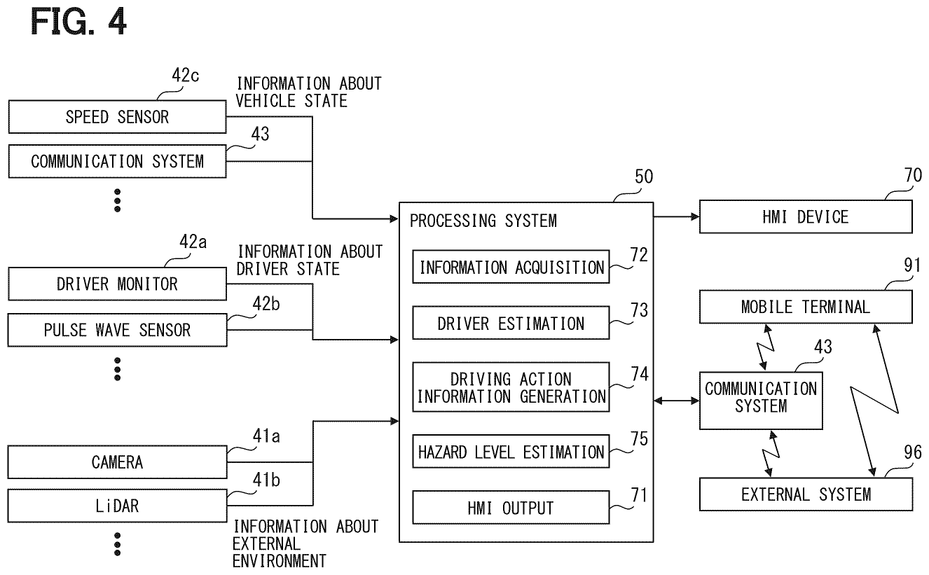

For example, in the processing system 50, the evaluation function and the teaching function may be implemented by further constructing functional blocks such as an information acquisition unit 72, a driver estimation unit 73, a driving action information generation unit 74, and a danger level estimation unit 75 as illustrated in FIG. 4 via the dedicated computer 51. When at least a part of functions implemented by the information acquisition unit 72, the driver estimation unit 73, the driving action information generation unit 74, and the danger level estimation unit 75 overlaps with functions of the environment judgement unit 21, the driving planning unit 22, and the mode management unit 23, an overlapping functional block may be responsible for the function.

The information acquisition unit 72 acquires information required for implementing the teaching function. The information required for implementing the teaching function may be, for example, various types of information such as the vehicle state, the driver state, and the external environment. Acquisition of these types of information may be direct acquisition of information about the detection data detected by the speed sensor 42c or the sensor 40 of the communication system 43 or the like or may be acquisition of information from the environment model generated based on the detection data.

The driver estimation unit 73 performs estimation related to the driver using the information acquired by the information acquisition unit 72. The estimation related to the driver may be at least one type of estimation of the current driver state, estimation of the driver state in the future, and estimation of the current intention of the driver.

The estimation of the driver state may include estimation as to whether the driver state is positive or negative. The estimation as to whether the driver state is positive or negative may be performed based on a facial expression and a heart rate of the driver.

For example, an analysis result as to whether the driver state is positive or negative may be obtained by inputting the information acquired by the information acquisition unit 72 into a trained neural network constructed in the processing system 50 as an input parameter. Specifically, a face image of the driver captured by the driver monitor 42a and heart rate data of the driver detected by the pulse wave sensor 42b are input into the neural network as input parameters. The estimation as to whether the driver state is positive or negative may be performed based on the analysis result output from the neural network. For example, the analysis result may indicate a numerical value of 0 to 100 for an index indicating each emotion of the driver. For example, when the index of emotion “Happy” of the driver is a high index, the driver state is estimated to be positive. For example, when the index of emotion “Sad” of the driver is high, the driver state is estimated to be negative.

The driving action information generation unit 74 detects the driving action of the driver and generates information related to the driving action. Generation of the information related to the driving action here may mean simple extraction of the behavior of the vehicle 1 as a result of the driving action of the driver. The generation of the information related to the driving action here may further include association between the behavior of the vehicle 1 and the external environment. Association between the behavior of the vehicle 1 and the external environment may be generation of information in which the external environment is associated with the behavior of the vehicle 1. The information in which the external environment is associated with the behavior of the vehicle 1 may be, for example, information indicating that the vehicle 1 travels through an intersection while the traffic light is displaying a stop signal, or information indicating that the vehicle 1 travels straight through the intersection from a dedicated right-turn lane.

The generation of the information related to the driving action may include further association of the information in which the external environment is associated with the behavior of the vehicle 1, with the rule defined by the safety model of autonomous driving.

The danger level estimation unit 75 estimates a danger level of driving performed by the driver. Estimation of the danger level here may be an example of evaluation of driving performed by the driver. The danger level here may indicate, for example, a possibility of interference or a possibility of collision with the other road user. For example, when the RSS model is employed as the safety model of autonomous driving, the danger level may be replaced with a responsibility value indicating a degree of responsibility of the vehicle 1 for an accident against the other road user, or may be a concept corresponding to the responsibility value.

The estimation of the danger level may include evaluation of driving performed by the driver using the rule defined by the safety model of autonomous driving. Evaluation using the rule defined by the safety model of autonomous driving may include determination as to whether the vehicle 1 violates the rule. This determination may be performed on an assumption that the vehicle 1 being manually driven is assumed to be autonomously driven. For example, this determination may include determination as to whether the vehicle 1 violates the safety envelope. For example, when the RSS model is employed as the safety model of autonomous driving, determination as to whether a distance between the vehicle 1 and the other road user such as the other vehicle is less than or equal to the safety distance may be included.

Evaluation using the rule defined by the safety model of autonomous driving may include evaluation based on a safety evaluation reference set based on the rule. The safety evaluation reference may include an indicator of at least one type of a possibility of collision with a surrounding object, a ratio of a blind spot of the road being traveled, and a collision avoidance probability when a collision avoidance action is performed. Determination as to whether the safety evaluation reference is satisfied may be determination based on a predetermined threshold value set for each indicator.

The estimation of the danger level may include detection of deviation between driving performed by the driver and the rule. The deviation may indicate a degree of violation with respect to the rule. For example, when driving performed by the driver does not violate the rule, the deviation may be 0. Detection of the deviation may be included in evaluation using the rule defined by the safety model of autonomous driving or may be separately performed after evaluation. When the deviation is calculated based on the safety evaluation reference, the deviation may be a difference between a value as a numerical value of evaluation at a time of violation calculated in actually evaluating the driving action of the driver as described above and a threshold value. When the deviation is calculated based on the safety evaluation reference, the deviation may be calculated based on a difference between a safety evaluation value and a threshold value. The deviation may be calculated as a composite or integrated parameter with respect to multiple rules or safety evaluation references.

The estimation of the danger level may include evaluation of a collision margin time with respect to the other road user. The collision margin time is an indicator indicating an amount of time after which a collision occurs when a current relative speed is maintained between the vehicle 1 and the other road user.

The estimation of the danger level may include evaluation of the driver state. Evaluation of the driver state may include determination based on an estimation result as to whether the driver state estimated by the driver estimation unit 73 is positive or negative.

The danger level may be estimated by any of the above evaluation and determination or may be estimated by combining the above evaluation and determination. The danger level may be estimated by classifying the danger level into three levels of a low danger level, a medium danger level, and a high danger level. The danger level may be estimated by classifying the danger level into multiple levels of two levels or four or more levels. The danger level may be indicated by consecutive values of 0 to 100.

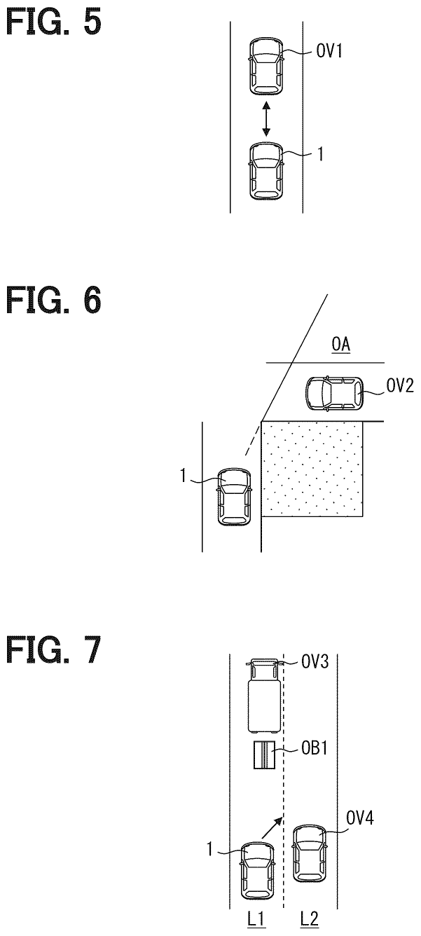

For example, as illustrated in FIG. 5, a scenario in which a vehicle-to-vehicle distance between the vehicle 1 and another preceding vehicle OV1 is smaller than the safety distance is considered. In this scenario, the possibility of collision is greater than a predetermined threshold value based on the rule. In this case, the danger level estimation unit 75 may estimate that the danger level of driving performed by the driver is high.

For example, as illustrated in FIG. 6, a scenario in which the vehicle 1 is excessively speeding at an obstructed intersection with poor visibility is considered. In this scenario, the driver is estimated to not expect emergence of another road user OV2 (for example, a safety-related object) from an obstructed region OA. In this case, the danger level estimation unit 75 may estimate that the danger level of driving performed by the driver is high.

For example, as illustrated in FIG. 7, a scenario in which the vehicle 1 is traveling in a left lane L1 of a road having two lanes on a single side, and another vehicle OV3 traveling ahead in the lane of the vehicle 1 suddenly drops a load OB1 is considered. In this scenario, still another vehicle OV4 traveling in a right lane L2 is present on the right of the vehicle 1. When the vehicle 1 further changes the lane to the right lane L2, the scenario is a composite scenario in which a load drop scenario and a cut-in scenario are combined. In this scenario, the collision avoidance probability is smaller than a predetermined threshold value. In this case, the danger level estimation unit 75 may estimate that the danger level of driving performed by the driver is high.

A process of outputting information for presenting the teaching to comply with the rule for the driver to the driver, in other words, information required for presentation (hereinafter, presentation required information), to at least one type of the HMI devices 70, the mobile terminal 91, and the external system 96 may be implemented by, for example, the HMI output unit 71.

The presentation required information may be, for example, at least one type of an estimation result of the estimation related to the driver, driving action information, and an estimation result of the danger level. As will be specifically described later, when presentation content for the driver is generated on a transmission side of the presentation required information, the presentation required information may be the presentation content for the driver.

Data of at least one type of the estimation result of the estimation related to the driver, the driving action information, and the estimation result of the danger level may be stored in the recording device 55 of the processing system 50. This data may be stored in the driving information DB 98 of the external system 96 by transmitting and receiving information through the communication system 43. The stored data may be used for determination for performing the teaching. The stored data may be used for generating the presentation content, described later. The stored data may be used for verification after an accident occurs.

When evaluation indicating violation of the rule is made, the HMI output unit 71 may output the presentation required information to at least one type of the HMI devices 70, the mobile terminal 91, and the external system 96. Meanwhile, when violation of the rule is not identified, the presentation required information may not be output or may be output as reference information in order to accumulate statistical data.

When evaluation indicating violation of the rule is made, the HMI output unit 71 may determine a presentation timing in accordance with at least one of the danger level, the deviation, the responsibility value, and urgency. The presentation timing may be selected from a timing during driving of the driver and a timing after an end of driving of the driver. At both of the timing during driving of the driver and the timing after the end of driving of the driver, the presentation content optimized for each timing may be presented.

As the timing during driving of the driver, a more specific timing such as a timing satisfying a predetermined condition (for example, a timing of a temporary stop at an intersection) during driving may be immediately selectable. As the timing after the end of driving of the driver, a more specific timing such as a timing during autonomous driving after takeover from manual driving to autonomous driving of levels 3 to 5 or a timing after arrival at the destination may be selectable.

At least one of the processing system 50 (for example, the HMI output unit 71) of the vehicle 1 on the transmission side of the presentation required information and the HMI devices 70, the mobile terminal 91, and the external system 96 on a reception side of the presentation required information may have a function of generating the presentation content for the driver.

The presentation content here may be visual information presentation content for presenting visual information such as static image content and video content. The presentation content may be audio information presentation content for presenting audio information such as voice content. The presentation content may be haptic information content for presenting haptic information. Furthermore, the presentation content may be content in which visual information and audio information are combined. Generation of the presentation content may be generation in accordance with a generation rule based on at least one of the rule of the safety model and the safety evaluation reference. Details of the presentation content may be determined by taking into consideration a driving habit of the driver and a comparison result between current driving and usual driving.

The generation of the presentation content may be implemented by selecting one piece of content from multiple pieces of content prepared in advance based on the estimation result of the driver state, the driving action information, and the estimation result of the danger level as the presentation required information. This selection may be performed using a condition complying with the above generation rule. The selected content may be partially changeable based on specific details of the driving action information.

The generation of the presentation content may be generation using a trained neural network that learns the above generation rule. Specifically, the estimation result of the driver state, the driving action information, and the estimation result of the danger level as the presentation required information are input into the neural network as input parameters, and the presentation content is output from the neural network. At least one type of the detection data of the external environment sensor 41, the environment model, and the vehicle state may be further added to the input parameters.

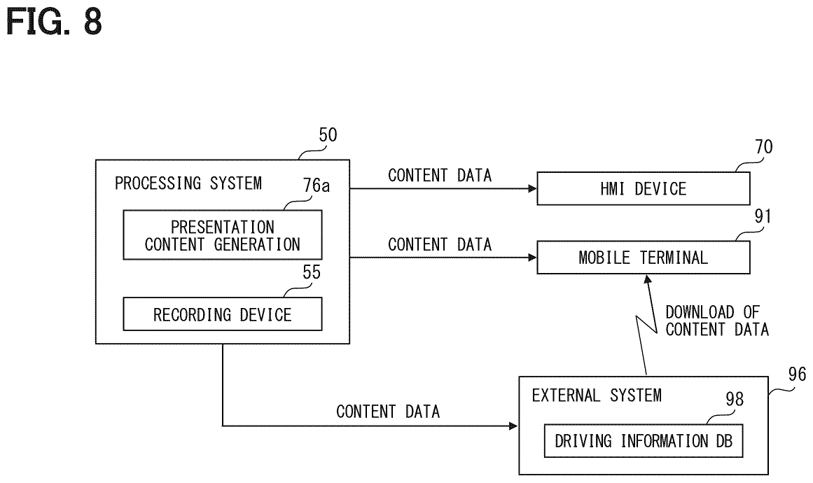

FIG. 8 illustrates an example in which a presentation content generation unit 76a as a functional block constructed by the dedicated computer 51 is provided in the processing system 50, and the presentation content is generated by the presentation content generation unit 76a. In the present example, the presentation content generation unit 76a generates the presentation content based on the estimation result of the estimation related to the driver, the driving action information, and the estimation result of the danger level recorded in the recording device 55. Generated content data may be directly transmitted to the HMI devices 70 and the mobile terminal 91 performing the teaching to the driver. Meanwhile, the generated content data may be provided to the mobile terminal 91 performing the teaching to the driver by transmitting the content data to the external system 96, then storing the content data in the driving information DB 98, and downloading the content data to the mobile terminal 91.

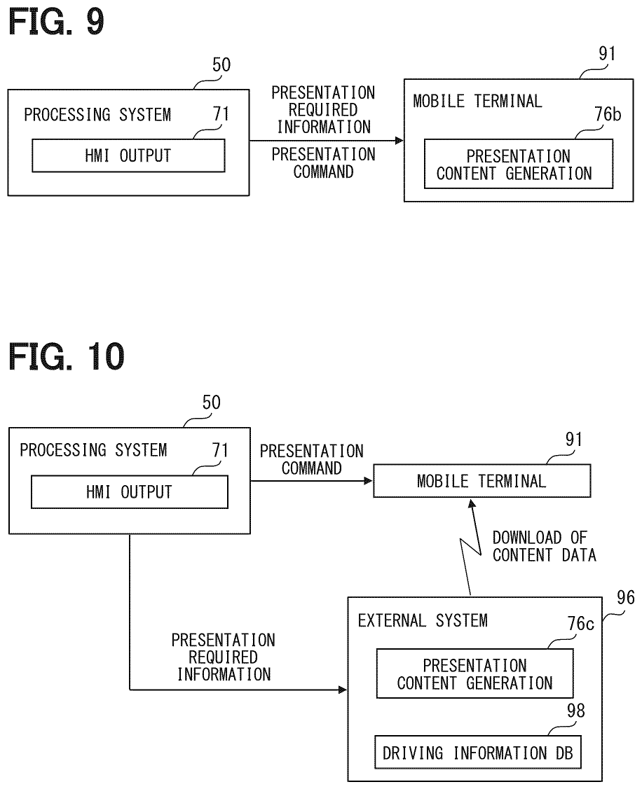

As another example, FIG. 9 illustrates an example in which a presentation content generation unit 76b as a functional block implemented using the dedicated computer 92 is provided in the mobile terminal 91. In the present example, the estimation result of the driver state, the driving action information, and the estimation result of the danger level as the presentation required information and a presentation command are output to the mobile terminal 91 from the HMI output unit 71 of the processing system 50. Accordingly, the presentation content generation unit 76b of the mobile terminal 91 generates the presentation content. This configuration may be implemented by downloading and installing a program for executing a content generation process via the presentation content generation unit 76b from a network or the external system 96 together with an application for performing the teaching.

As another example, FIG. 10 illustrates an example in which a presentation content generation unit 76c as a functional block implemented using the dedicated computer 97 is provided in the external system 96. In the present example, the estimation result of the driver state, the driving action information, and the estimation result of the danger level as the presentation required information are output to the external system 96 from the HMI output unit 71 of the processing system 50. Accordingly, the presentation content generation unit 76c of the external system 96 generates the presentation content. The presentation required information including the generated content data may be recorded in the driving information DB 98. Meanwhile, when the mobile terminal 91 receives the presentation command from the HMI output unit 71, the mobile terminal 91 may download the content data from the external system 96 and perform the teaching to the driver.

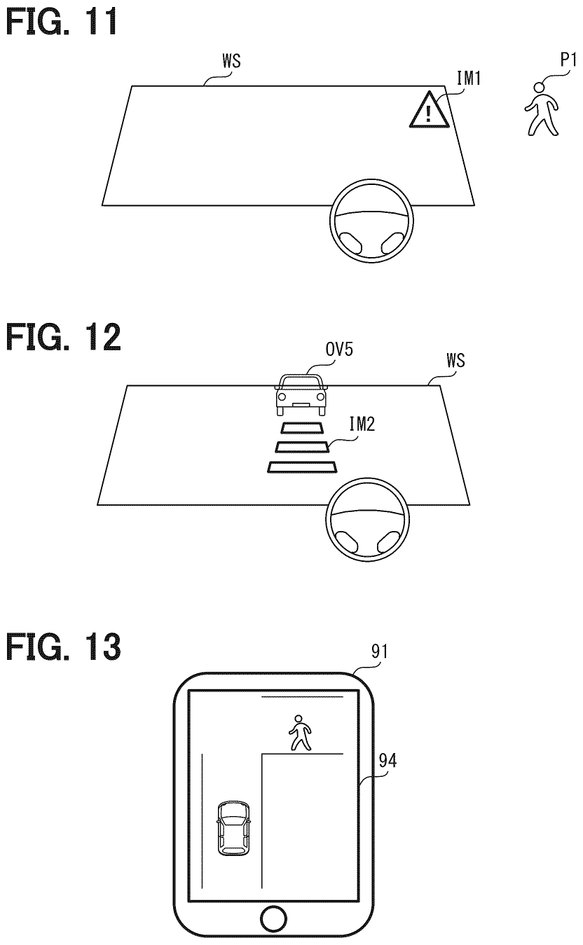

As an example of immediately performing the teaching, teaching using content in which display of the HUD and voice of the speaker are combined may be performed (refer to FIGS. 11 and 12). For example, FIG. 11 illustrates a teaching mode when a pedestrian P1 attempts to cross ahead of the vehicle 1 from the front right of the vehicle 1, and the pedestrian P1 is estimated to be not taken into consideration in driving of the driver. In this case, the HUD displays a virtual image of a teaching image IM1 to indicate presence of the pedestrian P1 in a part closest to the pedestrian P1 in a displayable region of a windshield WS of the vehicle 1. At the same time, the speaker, for example, emits teaching voice such as “Please pay attention to pedestrian at front right” for performing the teaching to take the pedestrian P1 into consideration in driving of the driver.

For example, FIG. 12 illustrates a teaching mode when a vehicle-to-vehicle distance between the vehicle 1 and another preceding vehicle OV5 is smaller than the safety distance. In this case, the HUD displays a virtual image of a teaching image IM2 for awareness of the vehicle-to-vehicle distance using multiple lateral lines in a part that is visually perceived behind the other preceding vehicle OV5 in the displayable region of the windshield WS of the vehicle 1. At the same time, the speaker, for example, emits teaching voice such as “Please keep vehicle-to-vehicle distance with preceding vehicle” for performing the teaching to take the vehicle-to-vehicle distance into consideration in driving of the driver.

As an example of performing the teaching after driving, teaching using content in which display of a video and voice provided by the mobile terminal 91 are combined as illustrated in FIG. 13 may be performed. The content here can be said to be content in which visual information indicating a scenario that is encountered by the vehicle 1 due to driving of the driver and audio information for providing advice on improving driving in the scenario are combined.

Specifically, the speaker of the mobile terminal 91 emits teaching voice such as “Scene that may lead to accident will be shown. You have habit of excessively speeding at location with blind spot. Please slow down at location with poor visibility in order to deal with pedestrian or bicycle that suddenly appears.” for suggesting the driver to correct a bad habit in driving of the driver. At the same time, the display of the mobile terminal 91 displays a teaching video illustrating a scenario that may lead to an accident.

The visual information presentation content to be used for the teaching is preferably generated in a mode in which privacy of the other road user is respected. For example, when visual information content is generated using information based on the detection data of the sensor 40, the content may be generated such that personal information of the other road user is not easily specified. For example, a video in which a face of a pedestrian captured by the camera 41a is processed to be blurred may be generated as the content.

When the teaching is performed by the mobile terminal 91, the teaching may be performed after the driver installs an application including a program for implementing the teaching function in advance on the mobile terminal 91. The teaching may be started by causing the driver to operate the application. The teaching may be automatically started in accordance with a reception timing of a driver teaching command.

As another example of performing the teaching after driving, teaching using a report based on the visual information presentation content provided by the meter, the CID, the HUD, the mobile terminal 91, or the like and on the audio information presentation content provided by the speaker may be performed.

Specifically, a report indicating “You have habit of deviating to outside when driving on curve, and there is possibility of collision with vehicle in adjacent lane. Please decelerate to reduce speed before entering curve and then make turn. Please drive with both hands holding steering wheel because this habit is also caused by single-hand driving that does not enable smooth steering wheel operation.” may be presented to the driver.

A report indicating “Today, vehicle-to-vehicle distance tends to be narrower than usual vehicle-to-vehicle distance. You will not be able to deal with sudden deceleration of preceding vehicle, and You are in danger of collision. Please keep driving with sufficient vehicle-to-vehicle distance in mind.” may be presented to the driver.

As described above, an upper limit of an information amount of the presentation content expected for the teaching during driving of the driver may be set to be smaller than an upper limit of an information amount of the presentation content expected for the teaching after driving of the driver. Furthermore, an upper limit of a playback time of the presentation content expected for the teaching during driving of the driver may be set to be smaller than an upper limit of a playback time of the presentation content expected for the teaching after driving of the driver. That is, the teaching during driving may be implemented in a mode in which the teaching during driving is shorter than the teaching after driving and provides notification of only main points.

At least one type of the information amount and the presentation timing of the presentation content to be presented is adjusted in accordance with the estimation result of the danger level. For example, when the danger level is estimated to be high, the presentation timing may be set to be during driving of the driver, and the information amount of the presentation content may be set to be smaller than the information amount of the presentation content when the danger level is estimated to be lower.

### <Processing Flow>

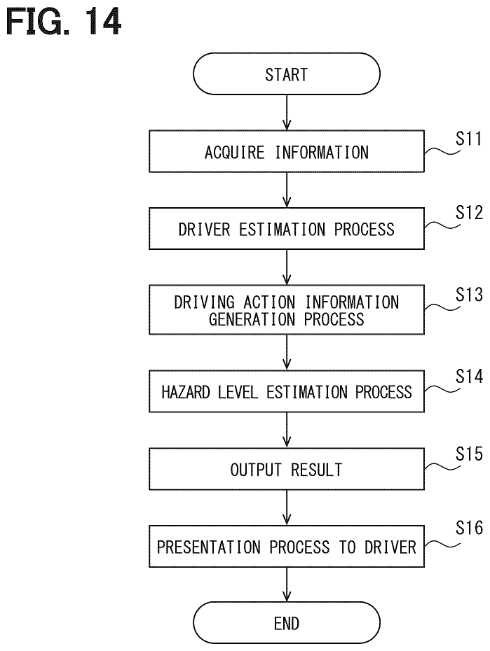

Next, an example of a processing method for implementing the evaluation function and the teaching function will be described using the flowchart in FIG. 14. A series of processes illustrated in steps S11 to S16 is executed by the driving system 2 for each predetermined time or based on a predetermined trigger. As a specific example, the series of processes may be executed for each predetermined time when the mode of autonomous driving is managed at level 0. As another specific example, the series of processes may be executed for each predetermined time when the mode of autonomous driving is managed at levels of 0 to 2.

As will be specifically described later, a part of the series of processes may be executed by at least one of the external system 96 and the mobile terminal 91. The series of processes may be executed in accordance with a computer program stored in a memory.

In first step S11, the information acquisition unit 72 acquires the information required for implementing the teaching function. After the process of S11, a transition is made to S12.

In S12, the driver estimation unit 73 performs the estimation related to the driver using the information acquired in S11. After the process of S12, a transition is made to S13.

In S13, the driving action information generation unit 74 generates the driving action information of the driver using the information acquired in S11. After the process of S13, a transition is made to S14. An order of the process of S12 and the process of S13 may be reversed, or the processes may be executed in parallel at the same time using, for example, two separate processors.

In S14, the danger level estimation unit 75 estimates the danger level using estimation in S12 and the driving action information in S13. After the process of S14, a transition is made to S15.

In S15, the HMI output unit 71 outputs the presentation required information to at least one type of the HMI devices 70, the mobile terminal 91, and the external system 96. Output of the presentation required information to the mobile terminal 91 or the external system 96 is actually transmission of the presentation required information through the communication system 43. After the process of S15, a transition is made to S16.

In S16, at least one of the HMI devices 70 and the mobile terminal 91 that already acquire the presentation content generated by the HMI devices 70 and the presentation required information, or the HMI devices 70 and the mobile terminal 91 that acquire the presentation required information and that generate the presentation content from the presentation required information perform the teaching to the driver. The series of processes is finished after S16.

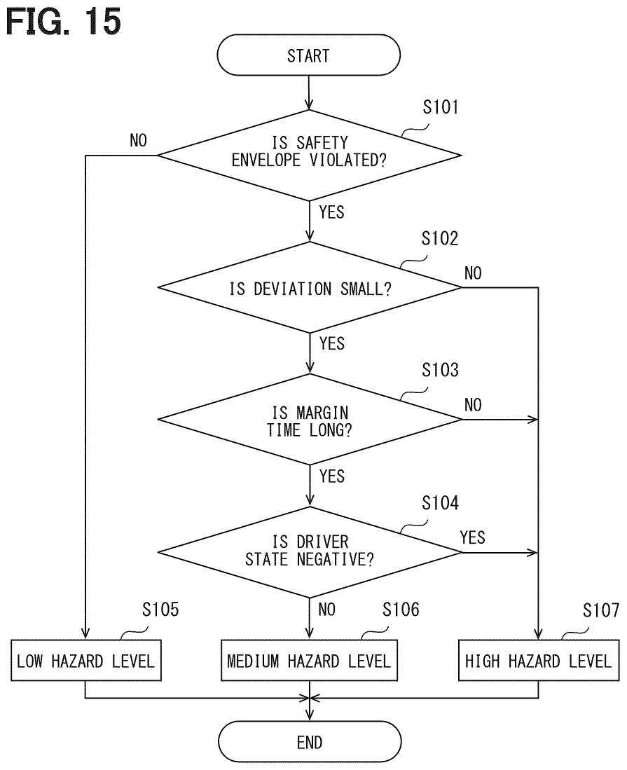

Next, an example of a processing method of estimating the danger level in S14 will be specifically described using the flowchart in FIG. 15.

In S101, the danger level estimation unit 75 determines whether driving of the driver violates the safety envelope based on the driving action information. When an affirmative determination is made in S101, a transition is made to S102. When a negative determination is made in S101, a transition is made to S105.

In S102, the danger level estimation unit 75 detects the deviation between driving of the driver and the rule and determines whether the deviation is smaller than a predetermined judgement reference value. The judgement reference value may be a fixed value set in advance. When the deviation is not easily compared with the judgement reference value because the deviation is not represented by a quantitative value, a negative determination may be made. When an affirmative determination is made in S102, a transition is made to S103. When a negative determination is made in S103, a transition is made to S107.

In S103, the danger level estimation unit 75 determines whether the margin time is longer than a predetermined judgement reference value. The judgement reference value may be a fixed value set in advance. When an affirmative determination is made in S103, a transition is made to S104. When a negative determination is made in S103, a transition is made to S107. When details of the determination in S103 actually overlap with details of the determination in S101, the process of S103 may be omitted.

In S104, the danger level estimation unit 75 determines whether the driver state is negative based on the estimation result of the driver estimation unit 73. When an affirmative determination is made in S104, a transition is made to S107. When a negative determination is made in S104, a transition is made to S106.

In S105, the danger level estimation unit 75 estimates that the danger level of driving of the driver is low. The series of processes is finished after S105.

In S106, the danger level estimation unit 75 estimates that the danger level of driving of the driver is medium. The series of processes is finished after S106.

In S107, the danger level estimation unit 75 estimates that the danger level of driving of the driver is high. The series of processes is finished after S107.

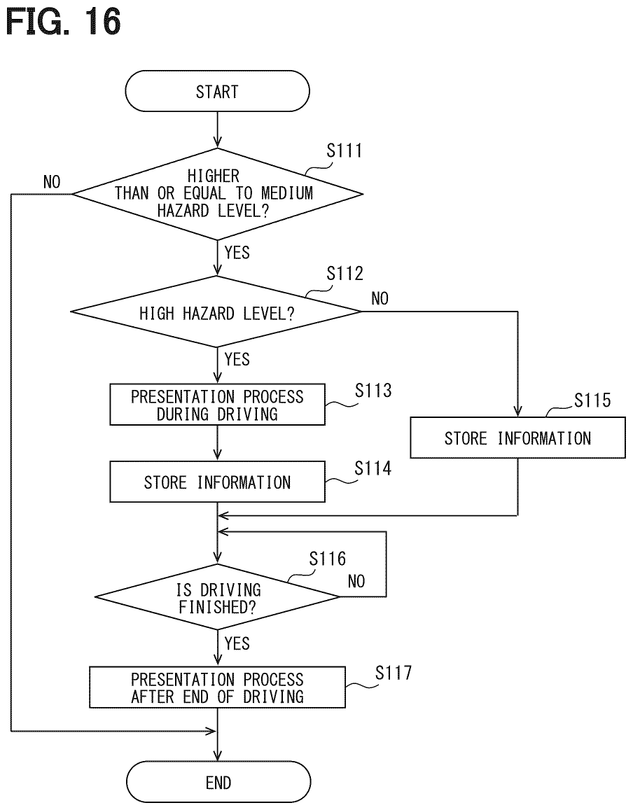

Next, an example of a processing method of exchanging information in S15 and S16 and performing the presentation to the driver will be specifically described using the flowchart in FIG. 16.

In S111, the HMI output unit 71 determines whether the danger level of driving of the driver is higher than or equal to the medium danger level, that is, the medium danger level or the high danger level. When an affirmative determination is made in S111, a transition is made to S112. When a negative determination is made in S111, the series of processes is finished.

In S112, the HMI output unit 71 determines whether the danger level of driving of the driver is estimated to be high. When an affirmative determination is made in S112, a transition is made to S113. When a negative determination is made in S112, a transition is made to S115.

In S113, the HMI output unit 71 and the HMI devices 70 perform a presentation process during driving of the driver. In the present example, when the danger level of driving of the driver is estimated to be high, the HMI output unit 71 selects to perform the teaching during driving of the driver. The HMI devices 70 perform the presentation to the driver, that is, the teaching, based on output of the presentation required information and the presentation command by the HMI output unit 71. After the process of S113, a transition is made to S114.

In S114, information such as the presentation required information and presentation history information of the presentation content is stored. These pieces of information may be stored in the recording device 55 as information about the vehicle 1 alone. These pieces of information may be stored in the driving information DB 98 in the external system 96 in a form of being accumulated together with information about multiple vehicles. After the process of S114, a transition is made to S116.

In S115, the presentation required information is stored. This information may be stored in the recording device 55 as information about the vehicle 1 alone. This information may be stored in the driving information DB 98 in a form of being accumulated together with information about multiple vehicles. After the process of S115, a transition is made to S116.

In S116, the HMI output unit 71 determines whether driving of the driver is finished. When an affirmative determination is made in S116, a transition is made to S117. When a negative determination is made in S116, S116 is performed again after, for example, an elapse of a predetermined time.

In S117, the HMI output unit 71 and at least one of the HMI devices 70 and the mobile terminal 91 perform a presentation process after the end of driving of the driver. In the present example, when the danger level of driving of the driver is estimated to be higher than or equal to the medium danger level, the HMI output unit 71 selects to perform the teaching after the end of driving of the driver. For example, at least one of the HMI devices 70 and the mobile terminal 91 may perform the presentation to the driver, that is, the teaching, based on the output of the presentation required information and the presentation command by the HMI output unit 71. For example, at least one of the HMI devices 70 and the mobile terminal 91 may perform the presentation to the driver, that is, the teaching, by acquiring and referring to the information stored in S115 and S116. The series of processes is finished after S117.

The presentation process (refer to S113) during driving of the driver and the presentation process (S117) after the end of driving of the driver may be performed in an overlapping manner with respect to the same driving action of the driver. The teaching may be performed multiple times after changing at least one type of the device, the information amount, and the presentation timing for performing the teaching with respect to the same driving action of the driver. By performing the teaching multiple times with changes in a presentation mode, validity of driving of the driver can be increased while inconvenience felt by the driver is reduced.

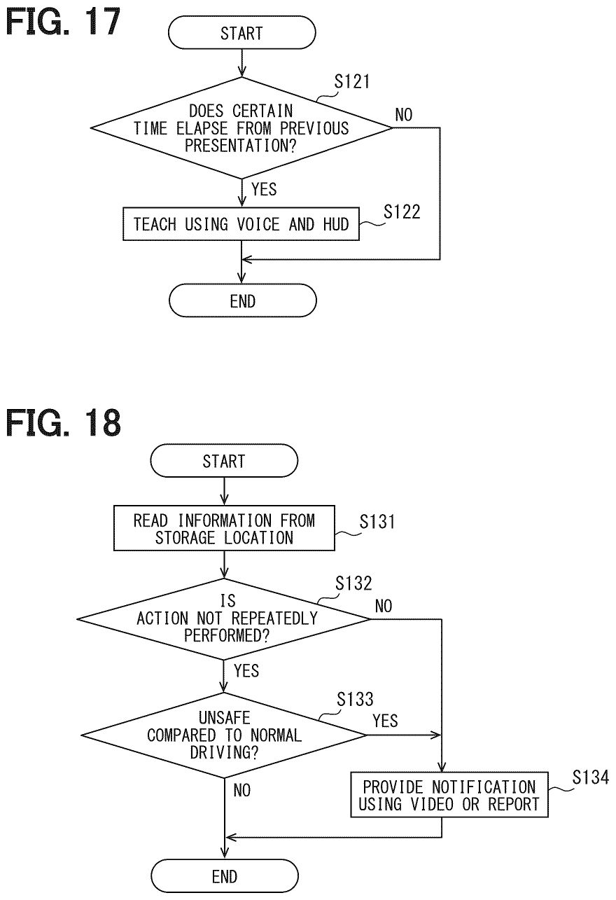

Next, an example of a processing method of performing the presentation during driving of the driver in S113 will be specifically described using the flowchart in FIG. 17.

In S121, when presentation of the same or similar details is performed in the past, the HMI output unit 71 determines whether a predetermined time elapses from the previous presentation. The predetermined time may be, for example, 1 minute, 10 minutes, or 1 hour. When an affirmative determination is made in S121, or when presentation of the same or similar details is not performed in the past, a transition is made to S122. When a negative determination is made in S121, the series of processes is finished.

In S122, the HMI devices 70 that receive the presentation command from the HMI output unit 71 perform the teaching in which the HUD and voice are combined, as described using FIGS. 11 and 12. The series of processes is finished after S122.

That is, when the danger level of driving of the driver is estimated to be high, the teaching during driving may be unconditionally performed, or the teaching may be omitted under a predetermined condition as in S122 and S122. By restricting an event in which the teaching with the same or similar details is performed multiple times in a short time, the inconvenience felt by the driver may be reduced.

Next, an example of a processing method of performing the presentation after the end of driving of the driver in S117 will be specifically described using the flowchart in FIG. 18.

In S131, the processing system 50 (for example, the HMI output unit 71) reads the information stored in S115 and S116 from a storage location. This reading may be implemented by transmitting and receiving information. After the process of S131, a transition is made to S132.

In S132, the HMI output unit 71 determines whether the driving action of the driver as a target is an action that is repeatedly performed. When an affirmative determination is made in S132, a transition is made to S133. When a negative determination is made in S132, a transition is made to S134.

In S132, the HMI output unit 71 determines whether the driving action of the driver as the target is an action that is repeatedly performed. When an affirmative determination is made in S132, a transition is made to S133. When a negative determination is made in S132, a transition is made to S134.

In S133, the HMI output unit 71 determines whether the driving action of the driver as the target is unsafe compared to a normal driving action of the driver. When an affirmative determination is made in S133, a transition is made to S134. When a negative determination is made in S133, the series of processes is finished.

In S134, at least one of the HMI devices 70 and the mobile terminal 91 that receive the presentation command from the HMI output unit 71 performs the teaching using the video or the teaching using the report as described using FIG. 13. The series of processes is finished after S134.

That is, when the danger level of driving of the driver is estimated to be the medium or high danger level, the teaching after the end of driving may be unconditionally performed, or the teaching may be omitted under a predetermined condition, as in S131 to S134. By restricting an event in which the teaching with details already understood by the driver is performed, the inconvenience felt by the driver may be reduced.

### Operation and Effects

Operation and effects of the first embodiment described above will be described below.

According to the processing system 50 of the first embodiment, information related to the teaching to the driver is output in a presentable manner to the driver. The rule as a reference for the teaching to the driver is defined by the safety model of autonomous driving. By causing the driver to refer to this teaching, adverse evaluation of driving of the driver in evaluation relative to an autonomously driven moving object can be restricted. Therefore, the validity of driving of the driver can be increased.

According to the HMI devices 70 and the mobile terminal 91 of the first embodiment, the user interfaces 70b and 94 present the presentation content based on the information that is related to the teaching to the driver and that is acquired from the communication interfaces 70a and 93. The rule as the reference for the teaching to the driver is defined by the safety model of autonomous driving. By causing the driver to refer to this teaching, adverse evaluation of driving of the driver in evaluation relative to an autonomously driven moving object can be restricted. Therefore, the validity of driving of the driver can be increased.

According to the first embodiment, the teaching corresponding to the deviation between driving of the driver and the rule is performed. Thus, the teaching can be optimized such that the driver can easily comply with the rule. Therefore, the validity of driving of the driver can be increased.

According to the first embodiment, the presentation mode of the presentation content for performing the teaching is determined. This determination is based on a result of the evaluation of driving of the driver. Thus, the teaching can be optimized such that the driver can easily comply with the rule. Therefore, the validity of driving of the driver can be increased.

According to the first embodiment, the presentation mode based on the result of the evaluation of driving of the driver includes a concept of the information amount. Thus, the teaching for complying with the rule can be performed while the inconvenience felt by the driver is reduced.

According to the first embodiment, the presentation mode based on the result of the evaluation of driving of the driver includes a concept of the presentation timing. Thus, the teaching for complying with the rule can be performed at a timing at which understanding of the driver can be easily promoted.

According to the first embodiment, during driving of the driver, the same or similar pieces of the presentation content are presented at a time interval greater than or equal to a predetermined time. Thus, the teaching for complying with the rule can be performed while the inconvenience felt by the driver is reduced.

According to the first embodiment, the presentation content in which the visual information indicating the scenario that is encountered by the vehicle 1 due to driving of the driver and the audio information for providing advice on improving driving in the scenario are combined is presented. The scenario presented using the visual information promotes understanding of a situation encountered by the driver in a short time. The advice indicated by the audio information can increase persuasiveness of the teaching. Therefore, the teaching with which the driver can easily comply with the rule can be implemented.

According to the first embodiment, when the user interfaces 70b and 94 present the presentation content, information read from the external system 96 is used. Continuous holding of information in the HMI devices 70 or the mobile terminal 91 between driving of the driver and the teaching can be restricted. Thus, the teaching can be performed while hardware resources mounted on the HMI devices 70 or the mobile terminal 91 are saved.

### Second Embodiment

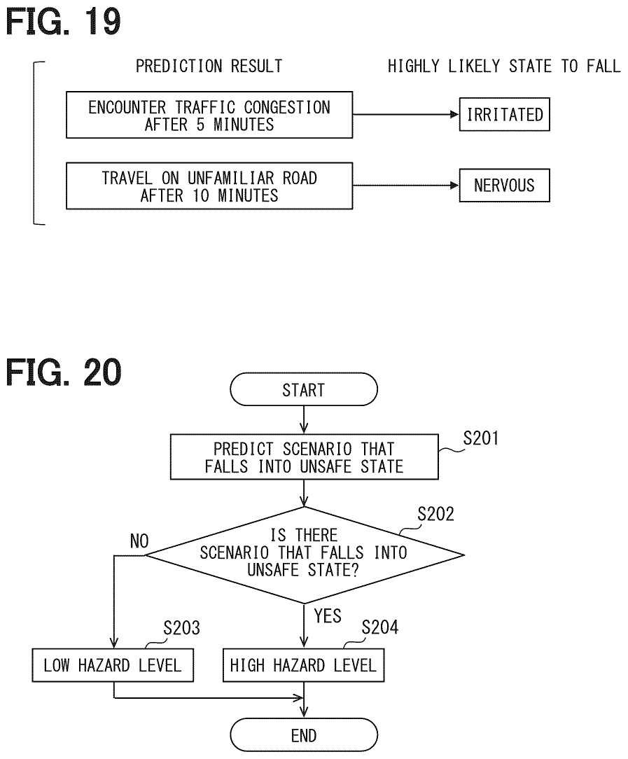

As illustrated in FIGS. 19 and 20, a second embodiment is a modification of the first embodiment. The second embodiment will be described with focus on its differences from the first embodiment.

In the second embodiment, a danger level estimation unit 75 predicts a scenario that may be encountered by a vehicle 1 before reaching a destination and, estimates a danger level based on the scenario. The danger level estimation unit 75 may predict a scene instead of a scenario. Specifically, the danger level estimation unit 75 predicts a path through which the vehicle 1 passes by driving of a driver, based on road information and destination information acquired using a map DB 44 and a V2X. Furthermore, the danger level estimation unit 75 predicts a scenario in which the vehicle 1 falls into unsafe condition, based on the road information related to the predicted path.

The scenario that falls into the unsafe condition may mean a hazardous situation or a scenario that is highly likely to fall into a so-called hazardous situation. The scenario that falls into the unsafe condition may mean a scenario in which the driver is highly likely to deviate from a rule defined by a safety model. The scenario predictable by the danger level estimation unit 75 corresponds to a known hazardous scenario.

The danger level estimation unit 75 may extract the scenario in which the vehicle 1 falls into the unsafe condition, by judging similarity between the scenario predicted to be encountered by the vehicle 1 and a hazardous scenario among concrete scenarios accumulated in a scenario DB 53.

Prediction of the unsafe condition in the scenario may be performed on an assumption about reasonably foreseeable behavior of another road user. This assumption may be based on consideration of the rule defined by the safety model. For example, when information obtained about another vehicle predicted in the scenario indicates that the other vehicle is a vehicle on which an RSS model is mounted, behavior of the other vehicle may be assumed based on a rule of the RSS model.

The scenario here may include a mental state of the driver (for example, at least one type of an intention and an emotion of the driver) as a factor for judging the unsafe condition. For example, as illustrated in FIG. 19, when the vehicle 1 is predicted to encounter traffic congestion after 5 minutes, an irritated state may be predicted as the mental state into which the driver is highly likely to fall. A scenario in which correlation between the irritated state and the unsafe condition is perceived among scenarios that are highly likely to be encountered by the vehicle 1 after encountering the traffic congestion may be extracted as the scenario in which the vehicle 1 falls into the unsafe condition.

For example, when the vehicle 1 is predicted to travel on an unfamiliar road after 10 minutes, a nervous state may be predicted as the mental state into which the driver is highly likely to fall. A scenario in which correlation between the nervous state and the unsafe condition is perceived among scenarios that are highly likely to be encountered by the vehicle 1 during traveling on an unfamiliar road may be extracted as the scenario in which the vehicle 1 falls into the unsafe condition.

An example of a processing method of estimating the danger level in the second embodiment will be specifically described using the flow in FIG. 20.

In S201, the danger level estimation unit 75 predicts the scenario in which the vehicle 1 falls into the unsafe condition. After the process of S201, a transition is made to S202.

In S202, the danger level estimation unit 75 determines whether the scenario that falls into the unsafe condition is predicted. When an affirmative determination is made in S202, a transition is made to S204. When a negative determination is made in S202, a transition is made to S203.

In S203, the danger level estimation unit 75 estimates that the danger level of driving of the driver is low. The series of processes is finished after S203.

In S204, the danger level estimation unit 75 estimates that the danger level of driving of the driver is high. The series of processes is finished after S204.

While the danger level is classified into two levels in this flow, the danger level may be classified into three levels or more or using consecutive numerical values in accordance with the predicted scenario. Teaching for changing the path, teaching for the mental state of the driver, and the like may be performed based on estimation of the danger level.

According to the second embodiment described above, a scenario as a target of teaching for causing the vehicle 1 to comply with the rule is a scenario that is predicted to be encountered by the vehicle 1 due to driving of the driver and that is predicted to cause the vehicle 1 to fall into the unsafe condition. By causing the driver to refer to this teaching, preparation for avoiding falling into the unsafe condition when the scenario indicated by the teaching is encountered can be made in advance. Thus, an effect of restricting adverse evaluation of driving of the driver is significantly increased.

According to the second embodiment, when occurrence of deviation between driving of the driver and the rule is predicted, presentation content is presented at a presentation timing before a predicted timing of the occurrence. By causing the driver to refer to this teaching, preparation for avoiding deviation of driving of the driver from the rule can be made in advance. Thus, the effect of restricting adverse evaluation of driving of the driver is significantly increased.

### Third Embodiment

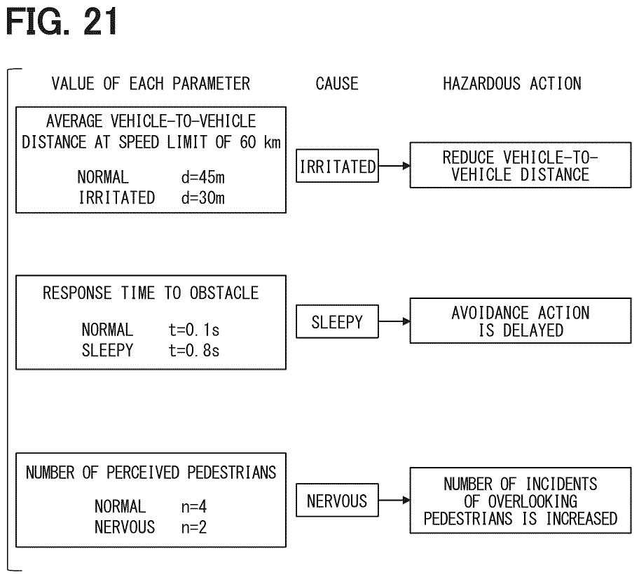

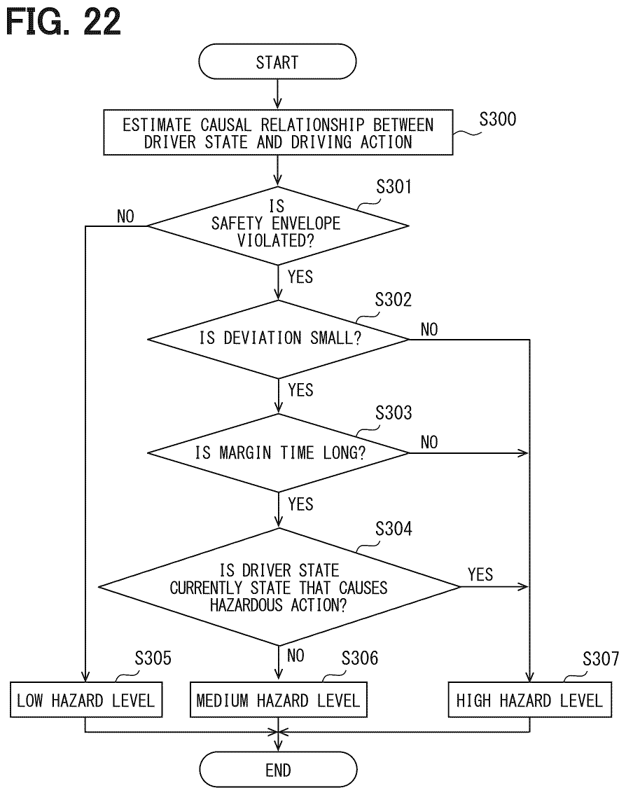

As illustrated in FIGS. 21 and 22, a third embodiment is a modification of the first embodiment. The third embodiment will be described with focus on its differences from the first embodiment.

In the third embodiment, a danger level estimation unit 75 estimates a causal relationship between a driver state and a driving action and estimates a danger level based on the causal relationship. Specifically, the danger level estimation unit 75 refers to a value of each parameter in driving action information. The danger level estimation unit 75 estimates a causal relationship between a driving action of a driver and a cause of a target driving action resulting from the driver based on the value of each parameter. The target driving action may be a dangerous driving action (hereinafter, a dangerous action).

As illustrated in FIG. 21, for example, data in which an average vehicle-to-vehicle distance d between a vehicle 1 and another preceding vehicle on a road with a speed limit of 60 km/h in the driving action of the driver of the vehicle 1 is normally 45 m when a mental state of the driver is normal and is 30 m when the driver is in an irritated state is obtained. In this case, the danger level estimation unit 75 estimates the causal relationship between the driver state “irritated state” and the driving action “reduce the vehicle-to-vehicle distance” with respect to this driver.

For example, data in which a response time t to behavior of another road user such as an obstacle in the driving action of the driver of the vehicle 1 is normally 0.1 s and is 0.8 s when the driver is sleepy is obtained. In this case, the danger level estimation unit 75 estimates the causal relationship between the driver state “sleepy state” and the driving action “avoidance action is delayed” with respect to this driver.

For example, data in which the number n of perceived pedestrians in the driving action of the driver of the vehicle 1 is normally four and is two when the driver is in a nervous state is obtained. In this case, the danger level estimation unit 75 estimates the causal relationship between the driver state “nervous state” and the driving action “number of incidents of overlooking pedestrians is increased”.

When the current driver state is a state that causes a dangerous action specified in estimating the causal relationship, the danger level estimation unit 75 may estimate the danger level to be higher than the danger level in other states.

An example of a processing method of estimating the danger level in the third embodiment will be specifically described using the flowchart in FIG. 22.

In S300, the danger level estimation unit 75 estimates the causal relationship between the driver state and the driving action of the driver. After the process of S300, a transition is made to S301.

In S301, the danger level estimation unit 75 determines whether driving of the driver violates a safety envelope based on driving action information. When an affirmative determination is made in S301, a transition is made to S302. When a negative determination is made in S301, a transition is made to S305.

In S302, the danger level estimation unit 75 detects deviation between driving of the driver and a rule and determines whether the deviation is smaller than a predetermined judgement reference value. When the deviation is not easily compared with the judgement reference value because the deviation is not represented by a quantitative value, a negative determination may be made. When an affirmative determination is made in S302, a transition is made to S303. When a negative determination is made in S302, a transition is made to S307.

In S303, the danger level estimation unit 75 determines whether a margin time is longer than a predetermined judgement reference value. When an affirmative determination is made in S303, a transition is made to S304. When a negative determination is made in S303, a transition is made to S307. When details of the determination in S303 actually overlap with details of the determination in S301, the process of S303 may be omitted.

In S304, the danger level estimation unit 75 determines whether the current driver state is a state causing the dangerous action, based on estimation of the causal relationship in S300. When an affirmative determination is made in S304, a transition is made to S307. When a negative determination is made in S304, a transition is made to S306.

In S305, the danger level estimation unit 75 estimates that the danger level of driving of the driver is low. The series of processes is finished after S305.

In S306, the danger level estimation unit 75 estimates that the danger level of driving of the driver is medium. The series of processes is finished after S306.

In S307, the danger level estimation unit 75 estimates that the danger level of driving of the driver is high. The series of processes is finished after S307.

The causal relationship between the driver state and the driving action of the driver used for estimating the danger level may be a causal relationship perceived for a general driver, instead of a causal relationship specialized for a specific driver who drives the vehicle 1.

According to the third embodiment described above, a factor of occurrence of a potential hazard is classified in accordance with the causal relationship between the driver state and the potential hazard in driving of the driver. Teaching corresponds to this classification of the factor of occurrence. Thus, persuasiveness of the teaching can be improved.

### Fourth Embodiment

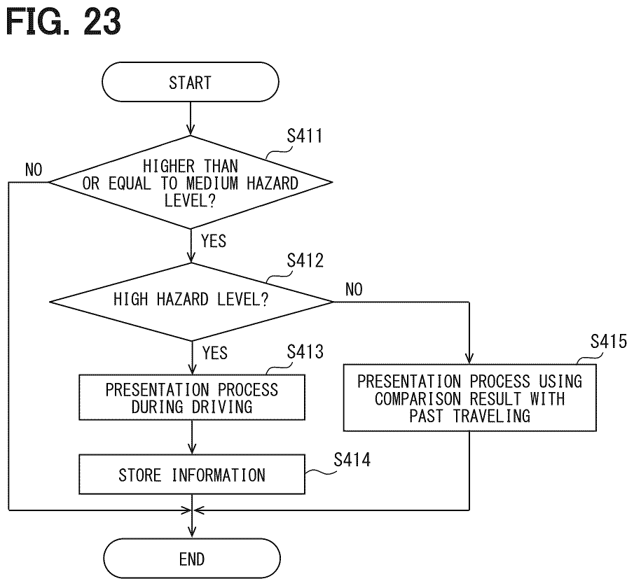

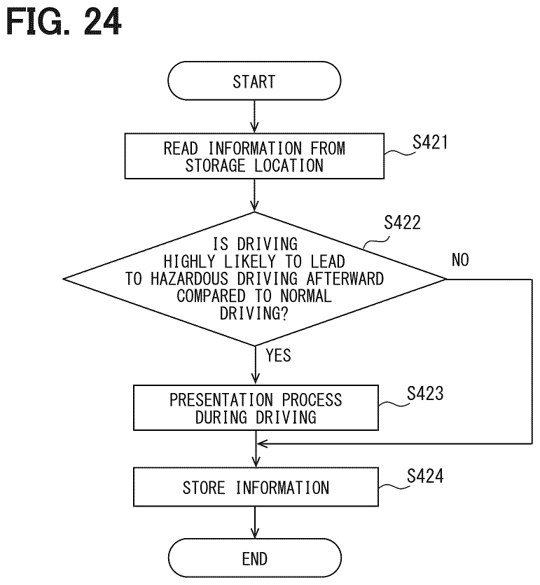

As illustrated in FIGS. 23 and 24, a fourth embodiment is a modification of the first embodiment. The fourth embodiment will be described with focus on its differences from the first embodiment.
a teaching function in the fourth embodiment has a mode that is specialized for teaching during driving of a driver. When an estimation result provided by a danger level estimation unit 75 indicates a high danger level, the same teaching as the first embodiment during driving of the driver is performed. When the estimation result provided by the danger level estimation unit 75 indicates a medium danger level, determination as to whether the teaching during driving of the driver is performed is performed in accordance with comparison between traveling performed by current driving of the driver and traveling (hereinafter, past traveling) performed by driving of the driver in the past.

An example of a processing method of performing presentation to the driver will be specifically described using the flowchart in FIG. 23.

In S411, an HMI output unit 71 determines whether the danger level of driving of the driver is higher than or equal to the medium danger level, that is, the medium danger level or the high danger level. When an affirmative determination is made in S411, a transition is made to S412. When a negative determination is made in S411, the series of processes is finished.

In S412, the HMI output unit 71 determines whether the danger level of driving of the driver is estimated to be high. When an affirmative determination is made in S412, a transition is made to S413. When a negative determination is made in S412, a transition is made to S414.

In S413, the HMI output unit 71 and HMI devices 70 perform a presentation process during driving of the driver. The presentation process may be the same as S121 and S122 illustrated in FIG. 17. After the process of S413, a transition is made to S414.

In S414, presentation required information is stored. This information may be stored in a recording device 55 as information about a vehicle 1 alone. This information may be stored in a driving information DB 98 in an external system 96 in a form of being accumulated together with information about multiple vehicles. The series of processes is finished after S414.

In S415, the HMI output unit 71 and the HMI devices 70 perform a presentation process using a comparison result with the past traveling. The series of processes is finished after S415.

Next, an example of a processing method of performing presentation using the comparison result with the past traveling in S415 will be more specifically described using the flowchart in FIG. 24.

In S421, a processing system 50 (for example, the HMI output unit 71) reads driving action information in the past in the presentation required information stored in S414 from a storage location. The driving action information in the past includes information related to the past traveling. This reading may be implemented by transmitting and receiving information. After the process of S421, a transition is made to S422.

In S422, the processing system 50 (for example, the HMI output unit 71) compares traveling performed by the current driving of the driver and the information related to the past traveling acquired in S421. The processing system 50 (for example, the HMI output unit 71) determines whether the current driving is highly likely to lead to dangerous driving afterward compared to normal (that is, past) driving. When an affirmative determination is made in S422, a transition is made to S423. When a negative determination is made in S422, a transition is made to S424.

In S423, the HMI output unit 71 and the HMI devices 70 perform the presentation process during driving of the driver. The presentation process may be the same as S121 and S122 illustrated in FIG. 17. After the process of S423, a transition is made to S424.

In S424, the presentation required information is stored, as in S414. The series of processes is finished after S424.

According to the fourth embodiment described above, a presentation mode of presentation content is determined based on comparison between the current driving and the past driving of the driver. Therefore, appropriate teaching corresponding to a driver state, a change in driving ability over time, and the like can be performed.

### Other Embodiments

While multiple embodiments are described above, the present disclosure is not interpreted as being limited to the embodiments and can be applied to various embodiments and combinations without departing from the gist of the present disclosure.

As Modification 1, a processing system that executes processes of a danger level estimation unit 75 and an HMI output unit 71 out of an evaluation function and a teaching function may be another system separated from a driving system 2. This processing system may be mounted or not mounted on a vehicle 1. This processing system may be provided in HMI devices 70 or a mobile terminal 91 or may be provided as an external system 96 such as a remote center.

As Modification 2, a processing system that executes the processes of the danger level estimation unit 75 and the HMI output unit 71 out of the evaluation function and the teaching function may be applied to a manually driven vehicle that is not capable of executing autonomous driving.

As Modification 3, a processing system that executes the processes of the danger level estimation unit 75 and the HMI output unit 71 out of the evaluation function and the teaching function may be applied to a vehicle that does not have a V2X function. In this case, teaching may be performed by only the HMI devices 70 mounted on the vehicle.

A control unit and its method according to the present disclosure may be implemented by a dedicated computer forming a processor that is programmed to execute one or multiple functions concretized by a computer program. Alternatively, a device and its method according to the present disclosure may be implemented by a dedicated hardware logic circuit. Alternatively, the device and its method according to the present disclosure may be implemented by one or more dedicated computers including a combination of a processor executing a computer program and one or more hardware logic circuits. The computer program may be stored in a computer-readable non-transient tangible recording medium as an instruction executed by a computer.

### Description of Terms

Terms related to the present disclosure will be described below. This description is included in the embodiments of the present disclosure.

A road user may be a person who uses a road including a sidewalk and other adjacent spaces. The road user may include a pedestrian, a cyclist, other VRUs, and a vehicle (for example, an automobile driven by a person or a vehicle equipped with an automated driving system). The road user may be a road user on or adjacent to an active road for a purpose of moving from a location to another location.

A dynamic driving task (DDT) may be a real-time operation function and a real-time strategic function for operating a vehicle in traffic.

An automated driving system may be hardware and software that are collectively capable of performing the entire DDT on a sustained basis, regardless of whether or not the autonomous driving system is limited to a specific operational design domain.

Safety of the intended functionality (SOTIF) may mean absence of an unreasonable risk caused by functional insufficiency for an intended function or its implementation.

A driving policy may be a strategy and a rule defining a control action at a vehicle level.

A scenario may be a description of a temporal relationship between several scenes, with goals and values within a specified situation in a sequence of scenes influenced by actions and events. The scenario may be a description of consecutive time series of activities integrates the subject vehicle, all its external environment, and their interaction in the process of performing a certain driving task.

A triggering condition may be a specific condition of a scenario that serves as an initiator for a subsequent system reaction contributing to either a hazardous behavior and reasonably foreseeable indirect misuse, which is a subsequent reaction of the system.

Takeover may be transfer of a driving task between an automated driving system and a driver.

A safety-related model may be a representation of a safety-related aspect of a driving action based on an assumption about reasonably predictable behavior of another road user. The safety-related model may be an on-board or off-board safety identification device or an on-board or off-board safety analysis device, a mathematical model, a set of more conceptual rules, a set of scenario-based behavior, or their combination.

A formal model may be model(s), expressed in formal notation, used in formal verification of system performance.

A safety envelope may be a set of limits and conditions, within which the system is designed to operate, subject to constraints or controls, in order to maintain operations within a level of acceptable risk. The safety envelope may be a general concept that can be used to deal with all principles on which the driving policy can be based. According to this concept, a subject vehicle operated by the (automated) driving system can have one or multiple boundaries around the subject vehicle.

A response time may be a time required for the road user to sense a specific stimulus and start executing a response (braking, steering, acceleration, stopping, or the like) in a given scenario.

A hazardous situation may be an increased risk for potential violation of a safety envelope, which also represents a level of increased risk present in the DDT.

### Disclosure of Technical Ideas

This description includes multiple technical ideas described in multiple items listed below. Some items may be written in a multiple dependent form with subsequent items referring to the preceding item as an alternative. The terms described in the multinomial dependent form define a plurality of technical ideas.

### (Technical Idea 1)

A recording device that records information related to a driver of a moving object, the device includes at least one storage medium. The recording device records driving behavior of the driver and a comparison result between the driving behavior and a rule defined by a safety model of autonomous driving or a criterion based on the rule in association with each other.

### (Technical Idea 2)

In the recording device according to the technical idea 1, the storage medium further records an estimation result of a driver state of the moving object in association with the driving behavior and the comparison result.

### (Technical Idea 3)

A processing method that executes a process for performing presentation to a driver of a moving object is provided. The method causes at least one processor to execute evaluating driving of the driver using a rule defined by a safety model of autonomous driving, and outputting information related to teaching for complying with the rule in a presentable manner to the driver when evaluation indicating violation of the rule is made.

### (Technical Idea 4)

A storage medium readable by at least one processor is provided. The storage medium stores a program that causes the processor to evaluate driving of a driver of a moving object using a rule defined by a safety model of autonomous driving, and output information related to teaching for complying with the rule in a presentable manner to the driver when evaluation indicating violation of the rule is made.

### (Technical Idea 5)

A program causes at least one processor to evaluate driving of a driver of a moving object using a rule defined by a safety model of autonomous driving, and output information related to teaching for complying with the rule in a presentable manner to the driver when evaluation indicating violation of the rule is made.

### (Technical Idea 6)

An information presentation method for presenting teaching related to driving to a driver is provided. The method includes: acquiring information used to evaluate the driving of the driver from at least one of an external environment or an internal environment of a vehicle using a sensor; calculating, by at least one processor, a degree of deviation of the driving of the driver from a rule defined by at least one safety model, which is at least one of an RSS (Responsibility-Sensitive Safety) model or an SFF (Safety Force Field) model of autonomous driving, based on the acquired information, the rule being stored in at least one recording medium; determining whether the calculated degree of deviation exceeds a predetermined threshold; outputting a signal to an information presentation device to present teaching for causing the driver to comply with the rule when it is determined that the degree of deviation exceeds the threshold; and presenting the teaching to the driver by the information presentation device upon receiving the signal.

### (Technical Idea 7)

An information presentation system for presenting teaching related to driving to a driver is provided. The system includes: a sensor provided in a vehicle and configured to acquire information used to evaluate the driving of the driver from at least one of an external environment or an internal environment of the vehicle; an in-vehicle processing system having at least one processor and at least one recording medium; and an information presentation device provided in the vehicle and configured to present the teaching to the driver. The at least one recording medium stores a rule defined by at least one safety model, which is at least one of an RSS (Responsibility-Sensitive Safety) model or an SFF (Safety Force Field) model of autonomous driving. The at least one processor calculates a degree of deviation of the driving of the driver from the rule based on the information acquired by the sensor, determines whether the calculated degree of deviation exceeds a predetermined threshold, and outputs a signal to the information presentation device to present teaching for causing the driver to comply with the rule when it is determined that the degree of deviation exceeds the threshold. The information presentation device is configured to present the teaching to the driver upon receiving the signal.

What is claimed is:

1. A processing system that executes a process for performing presentation to a driver of a moving object, the processing system comprising:
at least one processor,
wherein
the processor executes
evaluating driving of the driver using a rule defined by a safety model of autonomous driving,
detecting a degree of deviation between the driving of the driver and the rule in the evaluating or separately from the evaluating, and
outputting information related to teaching for complying with the rule in a presentable manner to the driver based on the evaluating,
wherein in the outputting, the information is output in accordance with the degree of the deviation.

2. The processing system according to claim 1, wherein
the processor further executes
perceiving a state of the driver,
extracting a causal relationship between the state of the driver and a potential hazard in the driving of the driver, and
classifying a factor of occurrence of the potential hazard in accordance with the causal relationship,
wherein the teaching is teaching corresponding to classification of the factor of occurrence.

3. A processing system that executes a process for performing presentation to a driver of a moving object, the processing system comprising:
at least one processor,
wherein
the processor executes
evaluating driving of the driver using a rule defined by a safety model of autonomous driving,
outputting information related to teaching for complying with the rule in a presentable manner to the driver based on the evaluating,
perceiving a state of the driver,
extracting a causal relationship between the state of the driver and a potential hazard in the driving of the driver, and
classifying a factor of occurrence of the potential hazard in accordance with the causal relationship,
wherein the teaching is teaching corresponding to classification of the factor of occurrence.

4. The processing system according to claim 1, wherein
the processor further executes predicting a scenario that is predicted to be encountered by the moving object due to the driving of the driver and in which the moving object falls into an unsafe condition, and
the teaching is teaching for causing the moving object to comply with the rule in the scenario in which the moving object falls into the unsafe condition.

5. A processing system that executes a process for performing presentation to a driver of a moving object, the processing system comprising:
at least one processor,
wherein
the processor executes
evaluating driving of the driver using a rule defined by a safety model of autonomous driving,
outputting information related to teaching for complying with the rule in a presentable manner to the driver based on the evaluating,
predicting a scenario that is predicted to be encountered by the moving object due to the driving of the driver and in which the moving object falls into an unsafe condition,
wherein the teaching is teaching for causing the moving object to comply with the rule in the scenario in which the moving object falls into the unsafe condition.

6. The processing system according to claim 1, wherein
the processor further executes determining a presentation mode of presentation content for performing the teaching based on a result of the evaluating of the driving of the driver.

7. A processing system that executes a process for performing presentation to a driver of a moving object, the processing system comprising:
at least one processor,
wherein
the processor executes
evaluating driving of the driver using a rule defined by a safety model of autonomous driving,
outputting information related to teaching for complying with the rule in a presentable manner to the driver based on the evaluating, and
determining a presentation mode of presentation content for performing the teaching based on a result of the evaluating of the driving of the driver.

8. The processing system according to claim 6, wherein
the presentation mode of the presentation content includes an information amount of the presentation content.

9. The processing system according to claim 6, wherein
the presentation mode of the presentation content includes a presentation timing of the presentation content.

10. The processing system according to claim 9, wherein
when the presentation timing is during the driving of the driver, a same or similar piece of the presentation content is presented at a time interval greater than or equal to a predetermined time.

11. The processing system according to claim 9, wherein
when occurrence of deviation between the driving of the driver and the rule is predicted, the presentation content is presented at the presentation timing before a timing of the predicted occurrence.

12. The processing system according to claim 6, wherein
the presentation mode of the presentation content is determined based on comparison between current driving and past driving of the driver.

13. The processing system according to claim 1, wherein
in the outputting, the information is output when evaluation indicating violation of the rule is made.

14. An information presentation device that performs presentation to a user, the device comprising:
a communication interface that is configured to communicate with a processing system which executes a process related to a moving object and that is configured to acquire information related to teaching for causing a driver of the moving object to comply with a rule defined by a safety model of autonomous driving from the processing system; and
a user interface that is configured to present presentation content related to the teaching for complying with the rule based on the information,
wherein
the presentation content includes content in which visual information indicating a scenario that is encountered by the moving object due to driving of the driver and audio information for providing advice on improving driving in the scenario are combined.

15. The information presentation device according to claim 14, wherein
the communication interface is configured to communicate with an external system provided outside the moving object, and
the user interface is configured to present the presentation content using information read from the external system.
